(19) United States
(12) Patent Application Publication
(10) Pub. No.: US 2022/0059830 A1
(43) Pub. Date: Feb. 24, 2022

(54) POSITIVE ELECTRODE MATERIAL FOR LITHIUM-ION SECONDARY BATTERY, SECONDARY BATTERY, ELECTRONIC DEVICE, VEHICLE, AND METHOD OF MANUFACTURING POSITIVE ELECTRODE MATERIAL FOR LITHIUM-ION SECONDARY BATTERY

(71) Applicant: SEMICONDUCTOR ENERGY LABORATORY CO., LTD., ATSUGI-SHI, KANAGAWA-KEN (JP)

(72) Inventors: Yohei MOMMA, Isehara, Kanagawa (JP); Teruaki OCHIAI, Atsugi, Kanagawa (JP); Mayumi MIKAMI, Atsugi, Kanagawa (JP); Jyo SAITO, Atsugi, Kanagawa (JP)

(73) Assignee: SEMICONDUCTOR ENERGY LABORATORY CO., LTD., ATSUGI-SHI, KANAGAWA-KEN (JP)

(21) Appl. No.: 17/274,880

(22) PCT Filed: Sep. 17, 2019
(86) PCT No.: PCT/IB2019/057789

§ 371 Date: Mar. 10, 2021

(30) Foreign Application Priority Data
Sep. 28, 2018 (JP) 2018-184689

(51) Int. Cl. H01M 4/505; C01G 53/00; H01M 4/525; H01M 4/36; H01M 10/0525; H01M 50/204; H01M 50/249

(52) U.S. Cl. CPC H01M 4/505; C01G 53/66; H01M 4/525; H01M 4/366; H01M 10/0525; H01M 2004/028; H01M 50/249; C01P 2004/04; C01P 2006/40; C01P 2002/85; C01P 2002/76; H01M 50/204

(57) ABSTRACT

A positive electrode material for a lithium-ion secondary battery which has high capacity and excellent charge and discharge cycle performance, and a manufacturing method thereof are provided, or a method of manufacturing a positive electrode material with high productivity is provided. The positive electrode material for a lithium-ion secondary battery includes a crystal represented by a crystal structure with a space group R-3m, a first region, and a second region, which is in contact with at least part of an outer side of the first region and whose outer edge corresponds to a surface of the first particle. The ratio of manganese atoms to cobalt atoms in the first region is lower than the ratio of manganese atoms to cobalt atoms in the second region. The ratio of fluorine atoms to oxygen atoms in the first region is lower than the ratio of fluorine atoms to oxygen atoms in the second region.

### TECHNICAL FIELD

One embodiment of the present invention relates to an object, a method, or a manufacturing method. One embodiment of the present invention relates to a process, a machine, manufacture, a composition of matter, or a composite. One embodiment of the present invention relates to a semiconductor device, a display device, a light-emitting device, a power storage device, a lighting device, an electronic device, or a manufacturing method thereof. In particular, one embodiment of the present invention relates to a positive electrode active material that can be used for a secondary battery, a positive electrode material that can be used for a secondary battery, a secondary battery, an electronic device including a secondary battery, or a vehicle including a secondary battery.

Note that in this specification, a power storage device refers to every element and device having a function of storing power. Examples of the power storage device include a storage battery (also referred to as a secondary battery) such as a lithium-ion secondary battery, a lithium-ion capacitor, and an electric double layer capacitor.

In addition, electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density have rapidly grown with the development of the semiconductor industry, for portable information terminals such as mobile phones, smartphones, tablets, and laptop computers; portable music players; digital cameras; medical equipment; next-generation clean energy vehicles (hybrid electric vehicles (HEV), electric vehicles (EV), plug-in hybrid electric vehicles (PHEV), and the like); and the like. The lithium-ion secondary batteries are essential as rechargeable energy supply sources for today's information society.

The performance required for lithium-ion secondary batteries includes much higher energy density, improved cycle performance, safety under a variety of environments, improved long-term reliability, and the like.

Thus, improvement of a positive electrode active material has been studied to improve the cycle performance and increase the capacity of lithium-ion secondary batteries. Patent Document 1 describes the valence of metal included in a positive electrode active material and the composition of the positive electrode active material. Patent Document 2 describes an example in which at least one kind of sulfur, phosphorus and fluorine is included in a composite oxide particle surface. Non-Patent Document 1 describes a thermal property of a compound including fluorine.

### REFERENCES

### Patent Documents

[Patent Document 1] Japanese Published Patent Application No. 2018-56118
[Patent Document 2] Japanese Published Patent Application No. 2011-82133

### Non-Patent Document

[Non-Patent Document 1] W. E. Counts et al., Journal of the American Ceramic Society, (1953), 36 [1] 12-17. FIG. 01471.

### SUMMARY OF THE INVENTION

### Problems to be Solved by the Invention

An object of one embodiment of the present invention is to provide a positive electrode material for a lithium-ion secondary battery which has high capacity and excellent charge and discharge cycle performance, and a manufacturing method thereof. Another object of one embodiment of the present invention is to provide a method of manufacturing a positive electrode material with high productivity. Another object of one embodiment of the present invention is to provide a positive electrode material that leads to the suppression of a capacity reduction due to charge and discharge cycles when used for a lithium-ion secondary battery. Another object of one embodiment of the present invention is to provide a high-capacity secondary battery. Another object of one embodiment of the present invention is to provide a secondary battery with excellent charge and discharge characteristics. Another object of one embodiment of the present invention is to provide a positive electrode active material in which elution of a transition metal such as cobalt is inhibited even when a state being charged with high voltage is held for a long time. Another object of one embodiment of the present invention is to provide a highly safe or reliable secondary battery.

Another object of one embodiment of the present invention is to provide a positive electrode active material that has high capacity and excellent charge and discharge cycle performance, and a manufacturing method thereof. Another object of one embodiment of the present invention is to provide a method of manufacturing a positive electrode active material with high productivity. Another object of one embodiment of the present invention is to provide a positive electrode active material that leads to the suppression of a capacity reduction due to charge and discharge cycles when used for a lithium-ion secondary battery.

Another object of one embodiment of the present invention is to provide a novel material, a novel active material particle, a novel composition, a novel composite, a novel power storage device, or a manufacturing method thereof.

Note that the objects of one embodiment of the present invention are not limited to the objects listed above. The objects listed above do not preclude the existence of other objects. Note that the other objects are objects that are not described in this section and will be described below. The objects that are not described in this section will be derived from the description of the specification, the drawings, and the like and can be extracted from the description by those skilled in the art. Note that one embodiment of the present invention is to solve at least one of the description listed above and/or the other objects.

### Means for Solving the Problems

[1] One embodiment of the present invention is a positive electrode material for a lithium-ion secondary battery, which includes a crystal represented by a crystal structure with a space group R-3m and a first particle. The first particle includes a first region and a second region. The second region is in contact with at least part of an outer side of the first region. The second region includes a region whose outer edge corresponds to a surface of the first particle. The first region and the second region each include manganese, cobalt, oxygen, and fluorine. The ratio of manganese atoms to cobalt atoms, oxygen atoms, and fluorine atoms included in the first region is manganese:cobalt:oxygen:fluorine=M1:C1:O1:F1. The ratio of manganese atoms to cobalt atoms, oxygen atoms, and fluorine atoms included in the second region is manganese:cobalt:oxygen:fluorine=M2:C2:O2:F2. The ratio of manganese atoms to cobalt atoms (M1/C1) in the first region is lower than the ratio of manganese atoms to cobalt atoms (M2/C2) in the second region. The ratio of fluorine atoms to oxygen atoms (F1/O1) in the first region is lower than the ratio of fluorine atoms to oxygen atoms (F2/O2) in the second region.

[2] In the above structure [1], preferably, the first region further includes nickel, and a region where the ratio of an L3 edge to an L2 edge (L3/L2) of nickel, which is obtained by measurement of the first region by electron energy loss spectroscopy, is higher than 3.3 is included.

[3] In the above structure [1] or [2], preferably, the positive electrode material for a lithium-ion secondary battery includes magnesium. The positive electrode material for a lithium-ion secondary battery includes a second particle. The second particle includes a region in contact with a surface of the first particle. The concentration of magnesium is greater than or equal to 10 times the sum of the concentrations of manganese, cobalt, and nickel in the second particle. The concentration of magnesium is less than or equal to 0.01 times the sum of the concentrations of manganese, cobalt, and nickel in the first particle.

[4] In any one of the above structures [1] to [3], preferably, the positive electrode material for a lithium-ion secondary battery includes phosphorus. The positive electrode material for a lithium-ion secondary battery includes a third particle. The third particle includes a region in contact with a surface of the first particle. The concentration of phosphorus is greater than or equal to 20 times the sum of the concentrations of manganese, cobalt, and nickel in the third particle. The concentration of phosphorus is less than or equal to 0.01 times the sum of the concentrations of manganese, cobalt, and nickel in the first particle.

[5] Another embodiment of the present invention is a lithium-ion secondary battery including a positive electrode including a positive electrode including the positive electrode material for a lithium-ion secondary battery described in any of the above, and a negative electrode.

[6] Another embodiment of the present invention is an electronic device including the lithium-ion secondary battery described in any of the above and a display portion.

[7] Another embodiment of the present invention is a vehicle including a battery pack including a combination of two or more lithium-ion secondary batteries described above.

[8] Another embodiment of the present invention is a method of manufacturing a positive electrode material for a lithium-ion secondary battery. The method includes a first step of mixing a lithium source, a fluorine source, and a magnesium source to form a first mixture, a second step of mixing a composite oxide including lithium, an element M, and oxygen with the first mixture to form a second mixture, and a third step of heating the second mixture to form a third mixture. In the second step, the element M is one or more selected from manganese, cobalt, nickel, and aluminum. In the third step, a heating temperature is higher than 630° C. and lower than 770° C. The number of atoms of magnesium included in the magnesium source of the first step is greater than or equal to 0.0005 times and less than or equal to 0.02 times the number of atoms of the element M included in the composite oxide of the second step. The number of atoms of fluorine included in the fluorine source of the first step is greater than or equal to 0.001 times and less than or equal to 0.02 times the number of atoms of the element M included in the composite oxide of the second step.

[9] In the above structure [8], preferably, the fourth mixture includes a particle including the element M, oxygen, and fluorine. The number of atoms of magnesium is less than 0.02 times the number of atoms of the element M in the particle when a cross section of the particle is measured with a transmission electron microscope by energy dispersive X-ray spectroscopy.

[10] In the above structure [8] or [9], preferably, the fourth mixture includes a particle including the element M, oxygen, and fluorine. The concentration of magnesium is less than 0.02 times the concentration of the element M in the particle when the particle is measured by X-ray photoelectron spectroscopy.

### Effect of the Invention

According to one embodiment of the present invention, a positive electrode material for a lithium-ion secondary battery which has high capacity and excellent charge and discharge cycle performance, and a manufacturing method thereof can be provided. According to one embodiment of the present invention, a method of manufacturing a positive electrode material with high productivity can be provided. According to one embodiment of the present invention, a positive electrode material that leads to the suppression of a capacity reduction due to charge and discharge cycles when used for a lithium-ion secondary battery can be provided. According to one embodiment of the present invention, a secondary battery with excellent charge and discharge characteristics can be provided. According to one embodiment of the present invention, a positive electrode active material in which elution of a transition metal such as cobalt is inhibited even when a state being charged with high voltage is held for a long time can be provided. According to one embodiment of the present invention, a highly safe or reliable secondary battery can be provided.

According to one embodiment of the present invention, a positive electrode active material that has high capacity and excellent charge and discharge cycle performance, and a manufacturing method thereof can be provided. According to one embodiment of the present invention, a method of manufacturing a positive electrode active material with high productivity can be provided. According to one embodiment of the present invention, a positive electrode active material that leads to the suppression of a capacity reduction due to charge and discharge cycles when used for a lithium-ion secondary battery can be provided.

A novel material, a novel active material particle, a novel composition, a novel composite, a novel power storage device, or a manufacturing method thereof can be provided.

Note that the effects of one embodiment of the present invention are not limited to the effects listed above. The effects listed above do not preclude the existence of other effects. Note that the other effects are effects that are not described in this section and will be described below. The other effects that are not described in this section will be derived from the description of the specification, the drawings, and the like and can be extracted from the description by those skilled in the art. Note that one embodiment of the present invention is to have at least one of the effects listed above and/or the other effects. Accordingly, depending on the case, one embodiment of the present invention does not have the effects listed above in some cases.

### BRIEF DESCRIPTION OF THE DRAWINGS

FIG. 1A is a diagram illustrating an example of a particle of one embodiment of the present invention. FIG. 1B is a diagram illustrating an example of a particle of one embodiment of the present invention.

FIG. 2A is a diagram illustrating an example of a particle of one embodiment of the present invention. FIG. 2B is a diagram illustrating an example of a particle of one embodiment of the present invention.

FIG. 3 is a diagram illustrating an example of a particle of one embodiment of the present invention.

FIG. 4A is a diagram illustrating an example of a particle of one embodiment of the present invention. FIG. 4B is a diagram illustrating an example of a particle of one embodiment of the present invention.

FIG. 5A is a diagram illustrating an example of a particle of one embodiment of the present invention. FIG. 5B is a diagram illustrating an example of a particle of one embodiment of the present invention.

FIG. 6 is a diagram illustrating an example of a method manufacturing of a positive electrode active material of one embodiment of the present invention.

FIG. 7 is a diagram illustrating an example of a method manufacturing of a positive electrode active material of one embodiment of the present invention.

FIG. 8 is a diagram illustrating an example of a method manufacturing of a positive electrode active material of one embodiment of the present invention.

FIG. 9 is a diagram illustrating an example of a method manufacturing of a positive electrode active material of one embodiment of the present invention.

FIG. 10A is a cross-sectional view of an active material layer when a graphene compound is used as a conductive additive. FIG. 10B is a cross-sectional view of an active material layer when a graphene compound is used as a conductive additive.

FIG. 11A is a diagram illustrating a charge method of a secondary battery. FIG. 11B is a diagram illustrating a charge method of a secondary battery. FIG. 11C is a diagram illustrating an example of a secondary battery voltage and a charge current.

FIG. 12A is a diagram illustrating a charge method of a secondary battery. FIG. 12B is a diagram illustrating a charge method of a secondary battery. FIG. 12C is a diagram illustrating a charge method of a secondary battery. FIG. 12D is a diagram illustrating an example of a secondary battery voltage and a charge current.

FIG. 13 is a diagram illustrating an example of a secondary battery voltage and a discharge current.

FIG. 14A is a diagram illustrating a coin-type secondary battery. FIG. 14B is a diagram illustrating a coin-type secondary battery. FIG. 14C is a diagram illustrating an example of charging.

FIG. 15A is a diagram illustrating a cylindrical secondary battery. FIG. 15B is a diagram illustrating a cylindrical secondary battery. FIG. 15C is a diagram illustrating a plurality of cylindrical secondary batteries. FIG. 15D is a diagram illustrating a plurality of cylindrical secondary batteries.

FIG. 16A is a diagram illustrating an example of a battery pack. FIG. 16B is a diagram illustrating an example of a battery pack.

FIG. 17A is a diagram illustrating an example of a battery pack. FIG. 17A is a diagram illustrating an example of a battery pack. FIG. 17A is a diagram illustrating an example of a battery pack. FIG. 17A is a diagram illustrating an example of a battery pack.

FIG. 18A is a diagram illustrating an example of a secondary battery. FIG. 18B is a diagram illustrating an example of a secondary battery.

FIG. 19 is a diagram illustrating an example of a secondary battery.

FIG. 20A is a diagram illustrating a wound body. FIG. 20B is a diagram illustrating a secondary battery. FIG. 20C is a diagram illustrating a secondary battery.

FIG. 21A is a diagram illustrating a secondary battery. FIG. 21B is a diagram illustrating a cross section of a secondary battery.

FIG. 22 is a diagram illustrating the appearance of a secondary battery.

FIG. 23 is a diagram illustrating the appearance of a secondary battery.

FIG. 24A is a diagram illustrating a method of manufacturing a secondary battery. FIG. 24B is a diagram illustrating a method of manufacturing a secondary battery. FIG. 24C is a diagram illustrating a method of manufacturing a secondary battery.

FIG. 25A is a diagram illustrating a bendable secondary battery. FIG. 25B is a diagram illustrating a bendable secondary battery. FIG. 25C is a diagram illustrating a bendable secondary battery. FIG. 25D is a diagram illustrating a bendable secondary battery. FIG. 25E is a diagram illustrating a bendable secondary battery.

FIG. 26A is a diagram illustrating a secondary battery. FIG. 26B is a diagram illustrating a secondary battery.

FIG. 27A is a diagram illustrating an example of an electronic device. FIG. 27B is a diagram illustrating an example of an electronic device. FIG. 27C is a diagram illustrating an example of a secondary battery. FIG. 27D is a diagram illustrating an example of an electronic device. FIG. 27E is a diagram illustrating an example of a secondary battery. FIG. 27F is a diagram illustrating an example of an electronic device. FIG. 27G is a diagram illustrating an example of an electronic device. FIG. 27H is a diagram illustrating an example of an electronic device.

FIG. 28A is a diagram illustrating an example of an electronic device. FIG. 28A is a diagram illustrating an example of an electronic device. FIG. 28C is a diagram illustrating an example of a charge and discharge control circuit.

FIG. 29 is a diagram illustrating examples of electronic devices.

FIG. 30A is a diagram illustrating an example of a vehicle. FIG. 30B is a diagram illustrating an example of a vehicle. FIG. 30C is a diagram illustrating an example of a vehicle.

FIG. 31 shows results of cross-sectional TEM observation.

FIG. 32A shows results of EDX analysis. FIG. 32B shows results of EDX analysis. FIG. 32C shows results of EDX analysis. FIG. 32D shows results of EDX analysis.

FIG. 33A shows results of EDX analysis. FIG. 33B shows results of EDX analysis. FIG. 33C shows results of EDX analysis. FIG. 33D shows results of EDX analysis. FIG. 33E shows results of EDX analysis. FIG. 33F shows results of EDX analysis.

FIG. 34A shows results of EDX analysis. FIG. 34B shows results of EDX analysis.

FIG. 35A shows results of EDX analysis. FIG. 35B shows results of EDX analysis.

FIG. 36A shows results of cross-sectional TEM observation. FIG. 36B shows results of cross-sectional TEM observation.

FIG. 37 shows results of EELS analysis.

FIG. 38 shows cycle performance of secondary batteries.

FIG. 39 is a charge and discharge curve of a secondary battery.

FIG. 40 shows cycle performance of secondary batteries.

FIG. 41 is charge and discharge curves of a secondary batteries.

### MODE FOR CARRYING OUT THE INVENTION

Embodiments of the present invention are described in detail with reference to the drawings. Note that the present invention is not limited to the following description, and it is readily understood by those skilled in the art that modes and details of the present invention can be modified in various ways. In addition, the present invention should not be construed as being limited to the description of embodiments below.

In this specification and the like, a surface portion of a particle of an active material or the like refers to a region from a surface to a depth of approximately 10 nm in some cases. A plane generated by a crack may also be referred to as a surface. In addition, a region whose position is deeper than that of the surface portion is referred to as an inner portion.

In this specification and the like, a layered rock-salt crystal structure of a composite oxide including lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In addition, in this specification and the like, a rock-salt crystal structure refers to a structure in which cations and anions are alternately arranged. Note that a cation or anion vacancy may exist.

Anions of a layered rock-salt crystal and anions of a rock-salt crystal have cubic closest packed structures (face-centered cubic lattice structures). Anions of a pseudo-spinel crystal are also presumed to have cubic closest packed structures. When the pseudo-spinel crystal is in contact with the layered rock-salt crystal and the rock-salt crystal, there is a crystal plane at which orientations of cubic closest packed structures composed of anions are aligned. Note that a space group of the layered rock-salt crystal and the pseudo-spinel crystal is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the pseudo-spinel crystal is different from that in the rock-salt crystal. In this specification, a state where the orientations of the cubic closest packed structures composed of anions in the layered rock-salt crystal, the pseudo-spinel crystal, and the rock-salt crystal are aligned is referred to as a state where crystal orientations are substantially aligned in some cases.

Whether the crystal orientations in two regions are substantially aligned can be judged from a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, and the like. X-ray diffraction (XRD), electron diffraction, neutron diffraction, and the like can also be used for judging. In the TEM image and the like, alignment of cations and anions can be observed as repetition of bright lines and dark lines. When the orientations of cubic closest packed structures in the layered rock-salt crystal and the rock-salt crystal are aligned, a state where an angle made by the repetition of bright lines and dark lines in the layered rock-salt crystal and the rock-salt crystal is less than or equal to 5°, further preferably less than or equal to 2.5° can be observed. Note that in the TEM image and the like, a light element such as oxygen or fluorine cannot be clearly observed in some cases; however, in such a case, alignment of orientations can be judged by arrangement of metal elements.

In addition, in this specification and the like, theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In addition, in this specification and the like, charge depth obtained when all lithium that can be inserted and extracted is inserted is 0, and charge depth obtained when all lithium that can be inserted and extracted and is contained in a positive electrode active material is extracted is 1.

In addition, in this specification and the like, charge refers to transfer of lithium ions from a positive electrode to a negative electrode in a battery and transfer of electrons from a negative electrode to a positive electrode in an external circuit. For a positive electrode active material, extraction of lithium ions is called charge. A positive electrode active material with a charge depth of greater than or equal to 0.7 and less than or equal to 0.9 may be referred to as a positive electrode active material charged with a high voltage.

Similarly, discharge refers to transfer of lithium ions from a negative electrode to a positive electrode in a battery and transfer of electrons from a positive electrode to a negative electrode in an external circuit. Discharge of a positive electrode active material refers to insertion of lithium ions. Furthermore, a positive electrode active material with a charge depth of less than or equal to 0.06 or a positive electrode active material from which more than or equal to 90% of the charge capacity is discharged from a state where the positive electrode active material is charged with high voltage is referred to as a sufficiently discharged positive electrode active material.

In addition, in this specification and the like, an unbalanced phase change refers to a phenomenon that causes a nonlinear change in physical quantity. For example, an unbalanced phase change might occur before and after peaks in a dQ/dV curve obtained by differentiating capacitance (Q) with voltage (V) (dQ/dV), which can largely change the crystal structure.

In this specification and the like, a positive electrode active material of one embodiment of the present invention can be used as a positive electrode material for a lithium-ion secondary battery. In this specification and the like, the positive electrode active material of one embodiment of the present invention can be used as a positive electrode material. In this specification and the like, the positive electrode active material of one embodiment of the present invention preferably includes a composition. In this specification and the like, the positive electrode active material of one embodiment of the present invention preferably includes a composite.

In this specification and the like, the positive electrode material for a lithium-ion secondary battery preferably functions as a positive electrode active material.

The positive electrode active material of one embodiment of the present invention includes a mixture of a first material including lithium, manganese, cobalt, oxygen, and fluorine, a second material including magnesium, and a third material including phosphorus, for example. The positive electrode active material of one embodiment of the present invention includes a composition including a mixture of a first material including lithium, manganese, cobalt, oxygen, and fluorine, a second material including magnesium, and a third material including phosphorus, for example.

The positive electrode active material of one embodiment of the present invention includes a mixture of a first particle including lithium, manganese, cobalt, oxygen, and fluorine, a second particle including magnesium, and a third particle including phosphorus, for example.

The positive electrode active material of one embodiment of the present invention includes a composite of a first material including lithium, manganese, cobalt, oxygen, and fluorine, a second material including magnesium, and a third material including phosphorus, for example. The composite may be formed by applying physical energy to the mixture of the first material to the third material, for example. The positive electrode active material of one embodiment of the present invention includes a composition including the composite of a first material including lithium, manganese, cobalt, oxygen, and fluorine, a second material including magnesium, and a third material including phosphorus, for example.

The positive electrode active material of one embodiment of the present invention includes a composite of a first particle including lithium, manganese, cobalt, oxygen, and fluorine, a second particle including magnesium, and a third particle including phosphorus, for example. The composite may be formed by applying physical energy to the mixture of the first particle to the third particle, for example.

For example, lithium cobalt oxide, lithium nickel-cobalt-manganese oxide, lithium nickel-cobalt-aluminum oxide, or the like is preferably used as a material with a space group R-3m for the positive electrode material for a lithium-ion secondary battery, in which case high discharge capacity might be obtained.

Manganese and nickel are preferred because their raw materials are more inexpensive than cobalt in some cases.

### Embodiment 1

In this embodiment, a positive electrode active material of one embodiment of the present invention is described.

### [Structure of Positive Electrode Active Material]

### Embodiment 1

In this embodiment, a positive electrode active material of one embodiment of the present invention is described.

According to the findings of the inventors, a positive electrode active material of one embodiment of the present invention is represented by a crystal structure with a space group R-3m, in a particle including a composite oxide including lithium, manganese and cobalt, the particle is mixed with a material or the like including fluorine to form a mixture, and the mixture is subjected to heat treatment, for example, at 700° C. and a temperature in the vicinity thereof, whereby a region where the concentration of manganese is higher than in a region on the inner side thereof is formed in the vicinity of a surface of the particle is formed. In the region, the concentration of fluorine might be higher and the concentration of oxygen might be lower than in the region on the inner side thereof. The inventors have found that, when the particle is used as a positive electrode active material of a secondary battery, a reduction in discharge capacity which is due to repetition of charge and discharge cycle can be inhibited. Note that a material including magnesium may be mixed in addition to the material including fluorine.

The positive electrode active material of one embodiment of the present invention preferably includes nickel. In the positive electrode active material of one embodiment of the present invention, preferably, the concentration of nickel is higher than the concentrations of cobalt and manganese and the concentration of cobalt is lower than the concentration of manganese.

The positive electrode active material of one embodiment of the present invention may include aluminum.

In the particle included in the positive electrode active material of one embodiment of the present invention, the valence of manganese is a first value in a first region; preferably, the valence of manganese is less than the first value in a second region where the distance from the surface is shorter than in the first region.

The particle included in the positive electrode active material of one embodiment of the present invention preferably includes a third region where the valence of nickel is estimated to be higher than 2.5 and a fourth region where the valence of nickel is estimated to be lower than 2.5.

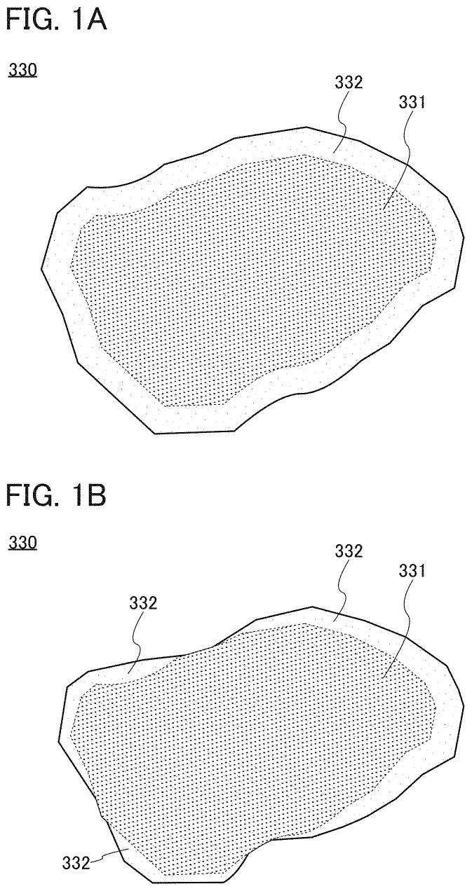

FIG. 1A and FIG. 1B show examples of cross sections of a particle 330 of one embodiment of the present invention. The particle 330 preferably functions as a positive electrode active material. The positive electrode active material of one embodiment of the present invention includes the particle 330.

As illustrated in FIG. 1A, the particle 330 preferably includes a region 331 and a region 332. The region 332 is in contact with at least part of the outer side of the region 331. Here, the outer side indicates closeness to a surface of the particle. The region 332 preferably includes a region corresponding to a surface of the particle 330 or preferably includes a region whose outer edge corresponds to the surface of the particle 330. As illustrated in FIG. 1B, the region 331 may include a region that is not covered with the region 332.

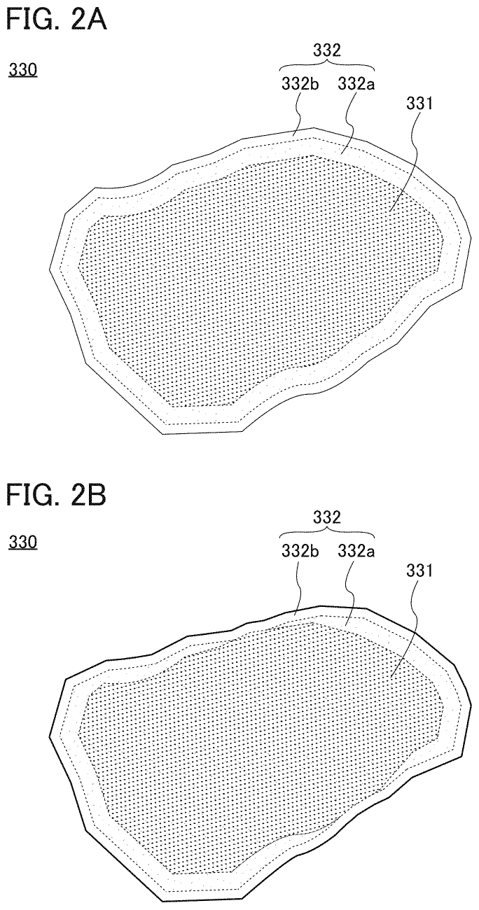

FIG. 2A shows an example in which the region 332 is separated into a region 332a and a region 332b. The region 332b is in contact with at least part of the outer side of the region 332a. The region 332b preferably includes a region corresponding to the surface of the particle 330.

As illustrated in FIG. 2B, the region 331 may include a region that is not covered with the region 332a. The region 331 may also include a region in contact with the region 332b. The region 331 may also include a region that is covered with neither the region 332a nor the region 332b.

A clear boundary between the region 331 and the region 332 is observed in some cases. A clear boundary between the region 332a and the region 332b is observed in some cases. The concentration gradient of a predetermined element is gradually changed from the region 331 to the region 332 in some cases. Furthermore, the concentration gradient of a predetermined element is gradually changed from the region 332a to the region 332b in some cases.

The region 331 is a region where the depth from the surface is preferably greater than 20 nm, further preferably greater than 30 nm, still further preferably greater than 50 nm, for example. The region 332 is a region where the depth from the surface is preferably less than 50 nm, further preferably less than 30 nm, still further preferably less than 20 nm, for example. The region 332b is located at a depth less than or equal to 5 nm, further preferably less than or equal to 3 nm from the surface, for example. The region 332a is located at a depth greater than or equal to 3 nm and less than or equal to 50 nm, further preferably greater than or equal to 5 nm and less than or equal to 30 nm from the surface, for example.

The concentration and valence of each element included in the region 331, the region 332, the region 332a, and the region 332b can be obtained by measurement at an arbitrary measurement point of each region, for example.

The concentration and valence of each element included in each region is preferably measured after a cross section of the particle 330 is exposed by processing.

The concentration of each element can be obtained by, for example, EDX (energy dispersive X-ray spectroscopy) using a TEM (transmission electron microscope).

The valence of each element can be obtained by, for example, electron energy loss spectroscopy (EELS).

The ratio of manganese atoms to cobalt atoms, nickel atoms, oxygen atoms, and fluorine atoms included in the region 331 is as follows: manganese:cobalt:nickel:oxygen:fluorine=M1:C1:N1:O1:F1. The ratio of manganese atoms to cobalt atoms, nickel atoms, oxygen atoms, and fluorine atoms included in the region 332 is as follows: manganese:cobalt:nickel:oxygen:fluorine=M2:C2:N2:O2:F2. The ratio of manganese atoms to cobalt atoms, nickel atoms, oxygen atoms, and fluorine atoms included in the region 332a is as follows: manganese:cobalt:nickel:oxygen:fluorine=M2a:C2a:N2a:O2a:F2a. The ratio of manganese atoms to cobalt atoms, nickel atoms, oxygen atoms, and fluorine atoms included in the region 332b is as follows: manganese:cobalt:nickel:oxygen:fluorine=M2b:C2b:N2b:O2b:F2.

### <Concentration of Transition Metal>

The concentration of manganese in the region 332 is preferably higher than the concentration of manganese in the region 331. In addition, M2/(M2+C2+N2) is preferably greater than M1/(M1+C1+N1).

For example, the concentration of nickel in the region 332 is preferably lower than the concentration of nickel in the region 331. In addition, N2/(M2+C2+N2) is preferably less than N1/(M1+C1+N1).

For example, N1/(M1+C1+N1) is preferably greater than or equal to 0.3 and less than or equal to 1.0, and N2/(M2+C2+N2) is preferably greater than or equal to 0.2 and less than or equal to 0.6.

For example, M1/(M1+C1+N1) is preferably greater than C1/(M1+C1+N1) and less than or equal to 3 times, further preferably greater than or equal to 1.3 times and less than or equal to 1.8 times C1/(M1+C1+N1).

Preferably, M2a/(M2a+C2a+N2a) and M2b/(M2b+C2b+N2b) are preferably greater than M1/(M1+C1+N1). Preferably, N2a/(M2a+C2a+N2a) and N2b/(M2b+C2b+N2b) are preferably less than N1/(M1+C1+N1).

A region from the surface to a depth of approximately 2 to 8 nm (normally, approximately 5 nm) can be analyzed by X-ray photoelectron spectroscopy (XPS); thus, the concentration of each element in approximately half of the surface portion can be quantitatively analyzed. In addition, the bonding states of the elements can be analyzed by narrow scanning analysis. Note that the quantitative accuracy of XPS is approximately ±1 atomic % in many cases. The lower detection limit depends on the element but is approximately 1 atomic %.

When the positive electrode active material of one embodiment of the present invention is analyzed by XPS and the sum of the concentrations of manganese, cobalt, and nickel is regarded as 1, the relative value of the magnesium concentration is preferably less than or equal to 0.1, further preferably less than 0.05, still further preferably less than 0.02. Furthermore, the relative value of the concentration of a halogen such as fluorine is preferably greater than or equal to 0.1 and less than or equal to 3.0, further preferably greater than or equal to 0.2 and less than or equal to 1.5.

In the XPS analysis, monochromatic aluminum can be used as an X-ray source, for example. An extraction angle is, for example, 45°.

In addition, when the positive electrode active material of one embodiment of the present invention is analyzed by XPS, a peak indicating the bonding energy of fluorine with another element is preferably higher than or equal to 682 eV and lower than 685 eV, further preferably approximately 684.8 eV. For example, when the positive electrode active material includes fluorine, bonding other than bonding of lithium fluoride and magnesium fluoride is preferable.

Furthermore, when the positive electrode active material of one embodiment of the present invention is analyzed by XPS, a peak indicating the bonding energy of magnesium with another element is preferably higher than or equal to 1302 eV and lower than 1304 eV, further preferably approximately 1303 eV. This value is different from the bonding energy of magnesium fluoride, which is 1305 eV, and is close to the bonding energy of magnesium oxide. That is, when the positive electrode active material includes magnesium, bonding other than bonding of magnesium fluoride is preferable.

### <Valence of Transition Metal>

The valence of manganese included in the region 332a and the valence of manganese included in the region 331 are each preferably higher than the valence of manganese included in the region 332b.

The valence of manganese included in the region 332b is preferably lower than 3, further preferably lower than 2.5, for example. The valence of manganese included in the region 332a and the valence of manganese included in the region 331 are preferably higher than or equal to 3, further preferably higher than 3.5, for example.

The ratios of the L3 edge to the L2 edge (L3/L2) of manganese obtained by EELS measured in the region 331, the region 332a, and the region 332b are denoted by L_Mn1, L_Mn2a, and L_Mn2b, respectively. L_Mn2b is preferably greater than or equal to 2.7, further preferably greater than 3. L_Mn1 and L_Mn2a are each preferably less than or equal to 2.5, further preferably less than 2.3.

The particle 330 of one embodiment of the present invention sometimes include a region where the ratio of the L3 edge to the L2 edge (L3/L2) of nickel obtained by EELS measurement is greater than 3.3.

### <Fluorine>

F_2/O_2 is preferably higher than F_1/O_1.

### <Element A>

The positive electrode active material of one embodiment of the present invention sometimes includes the particle 330 and a particle 350 including an element A. For example, at least one or more of magnesium, sodium, and potassium is preferably used as the element A.

In a manufacturing process of the positive electrode active material described later, mixing a halide of the element A with a lithium halide sometimes reduces the melting point. This may facilitate introduction of a halogen into the region 332, for example. Here, when the element A enters a site of a transition metal, the crystal structure sometimes becomes unstable. In order that excessive introduction of the element A be avoided, the heating temperature is preferably low.

The element A is preferably a metal where substitution with a transition metal such as manganese, cobalt, or nickel included in the positive electrode active material is unlikely to occur.

The entire surface of the particle is a kind of crystal defects and lithium is extracted from the surface during charge; thus, the lithium concentration in the surface of the particle tends to be lower than that inside the particle. Therefore, the surface of the particle tends to be unstable and its crystal structure is likely to be broken.

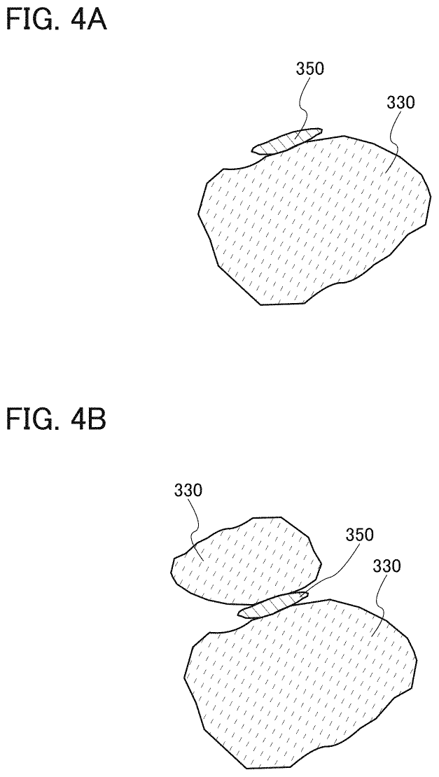

As illustrated in FIG. 4A, the particle 350 is sometimes positioned on the surface of the particle 330, for example. Alternatively, as illustrated in FIG. 4B, the particle 350 is sometimes positioned between a plurality of particles 330, for example.

In the particle 350, the concentration of the element A is preferably higher than or equal to 10 times, further preferably higher than or equal to 20 times the sum of the concentrations of manganese, cobalt, and nickel. In the particle 330, the concentration of the element A is preferably lower than or equal to 0.001 times the sum of the concentrations of manganese, cobalt, and nickel.

When the particle 330 of one embodiment of the present invention includes the region 332, a composite oxide that differs in composition from the inside is preferably formed in the vicinity of the surface of the particle 330. A composite oxide formed in the vicinity of the surface preferably has a manganese content higher than that in the inside and includes fluorine, for example. Probably, the composite oxide having such features is less changed in crystal structure by charging and discharging of a secondary battery, and the crystal structure is stable also on the surface of the particle. As lithium is released in a charging process of the secondary battery, the valence of nickel is sometimes reduced from an approximate value of 3 to an approximate value of 2, for example. As the valence of nickel is reduced, oxygen might be easily released. Probably, the crystal structure is made stable by a bond between a metal and fluorine formed by replacement of part of oxygen with fluorine, for example. Alternatively, as the concentration of nickel in the vicinity of the surface increases, nickel enters a lithium site, which might easily cause cation mixing. Cation mixing can be less likely to be generated by an increase in the concentration of manganese in some cases.

### <Grain Boundary>

Like a particle surface, a crystal grain boundary is also a plane defect. Thus, a crystal grain boundary tends to be unstable and its crystal structure easily changes.

Thus, a crystal grain boundary preferably has the features described for the region 332, which are the composition of the elements and the valences of the metals. For example, such features might enable a secondary battery using the particle 330 as a positive electrode active material to have excellent cycle performance.

A grain boundary is sometimes observed between crystals. A grain boundary is observed by TEM observation or the like, for example. A grain boundary is a boundary between two crystals in the particle 330 which have different crystal orientations and are in contact with each other, for example.

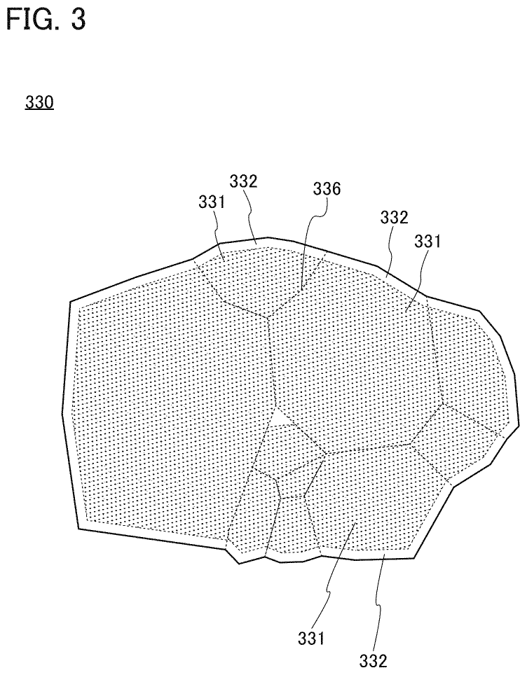

FIG. 3 shows an example in which the particle 330 is formed of an aggregate of a plurality of crystals. In the example shown in FIG. 3, one or more of the plurality of crystals include the region 331 and the region 332. In some cases, the crystals do not include the region 332. For example, a grain boundary 336 is observed between two crystals. In the example shown in FIG. 3, the grain boundary 336 is observed between boundaries of the regions 331 included in two crystals.

The description of the region 332a might be applied to the concentration of each element and the valence of the metal in the grain boundary 336 and a region in the vicinity thereof, or more specifically in the grain boundary 336 and the vicinity thereof within a range of approximately 10 nm observed in a cross section of the particle 330, for example. In such a case, the relationship between the region 332a and the region 331, for example, can be applied to the relationship between the grain boundary 336 and the vicinity thereof and the region 331 in some cases.

### <Element X>

It is preferable that the positive electrode active material of one embodiment of the present invention include an element X, and phosphorus be used as the element X The positive electrode active material of one embodiment of the present invention further preferably includes a compound including phosphorus and oxygen.

When the positive electrode active material of one embodiment of the present invention includes a compound including the element X, a short circuit is less likely to occur while the high-voltage charged state is maintained in some cases.

When the positive electrode active material of one embodiment of the present invention contains phosphorus as the element X, phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in hydrogen fluoride concentration in the electrolyte solution can inhibit corrosion and coating film separation of a current collector in some cases. Furthermore, the decrease in hydrogen fluoride concentration in the electrolyte solution can inhibit a reduction in adhesion properties due to gelling or insolubilization of PVDF in some cases.

When containing magnesium in addition to the element X, the positive electrode active material of one embodiment of the present invention is extremely stable in the high-voltage charged state. When the element X is phosphorus, the number of phosphorus atoms is preferably 1% or more and 20% or less, further preferably 2% or more and 10% or less, still further preferably 3% or more and 8% or less of the number of cobalt atoms. In addition, the number of magnesium atoms is preferably 0.1% or more and 10% or less, further preferably 0.5% or more and 5% or less, still further preferably 0.7% or more and 4% or less of the number of cobalt atoms. The phosphorus concentration and the magnesium concentration described here may each be a value obtained by element analysis on the entire particle of the positive electrode active material using inductively coupled plasma mass spectrometry (ICP-MS) or the like, or may be a value based on the ratio of the raw materials mixed in the process of forming the positive electrode active material, for example.

In the case where the particle 330 included in the positive electrode active material has a crack, phosphorus, more specifically, a compound including phosphorus and oxygen, in the inner portion of the crack may inhibit crack development, for example.

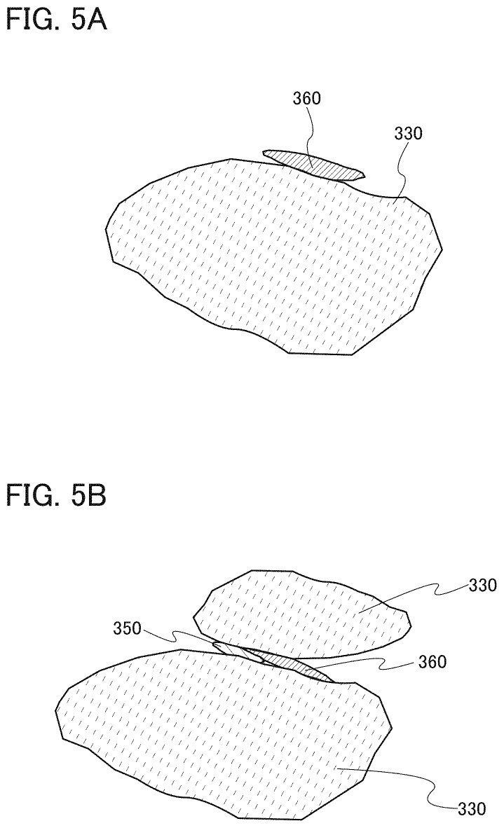

The positive electrode active material of one embodiment of the present invention preferably includes the particle 360 including the element X. As illustrated in FIG. 5A, the particle 360 is sometimes positioned on the surface of the particle 330, for example. Alternatively, as illustrated in FIG. 5B, the particle 360 is sometimes positioned between the plurality of particles 330.

In the particle 360, the concentration of phosphorus is preferably higher than or equal to 10 times, further preferably higher than or equal to 20 times the sum of the concentrations of manganese, cobalt, and nickel. In the particle 330, the concentration of phosphorus is preferably lower than or equal to 0.001 times the sum of the concentrations of manganese, cobalt, and nickel.

### <Particle Size>

A too large particle size of the positive electrode active material causes problems such as difficulty in lithium diffusion and too much surface roughness of an active material layer in coating to a current collector. By contrast, a too small particle size causes problems such as difficulty in carrying the active material layer in coating to the current collector and overreaction with an electrolyte solution. Therefore, an average particle size (D50, also referred to as median diameter) is preferably more than or equal to 1 μm and less than or equal to 100 μm, further preferably more than or equal to 2 μm and less than or equal to 40 μm, still further preferably more than or equal to 5 μm and less than or equal to 30 μm.

### [Forming Method 1 of Positive Electrode Active Material]

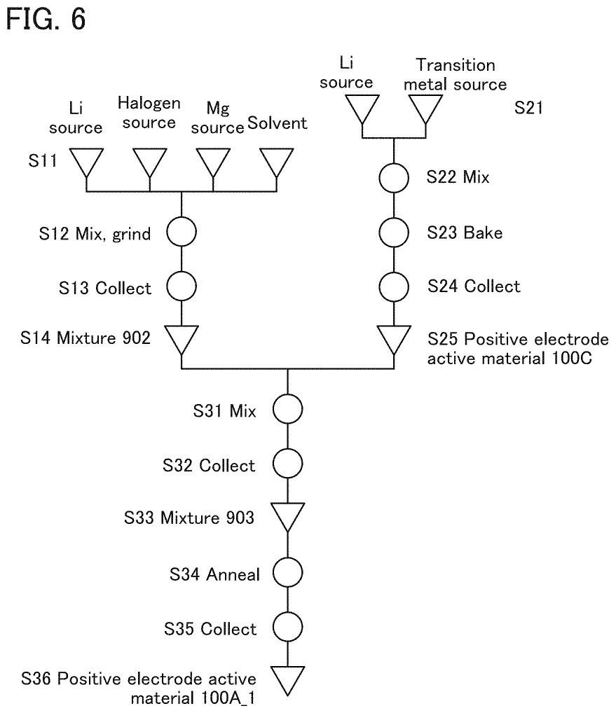

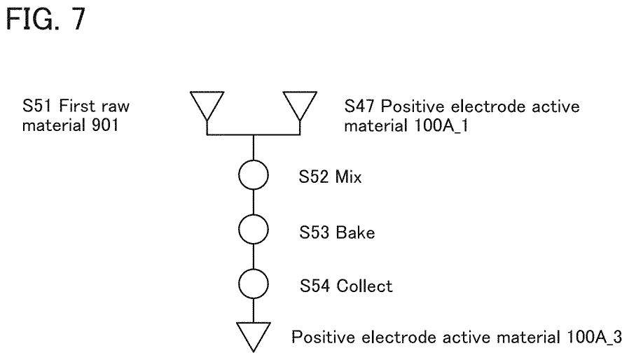

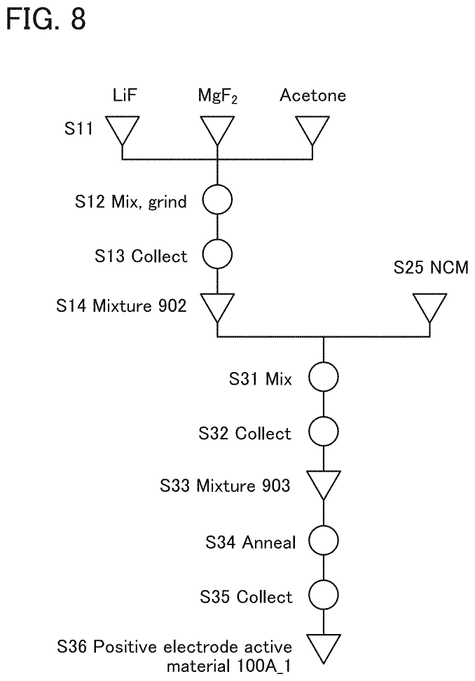

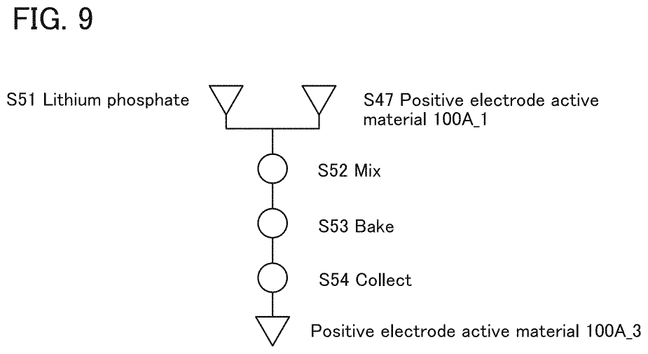

Next, an example of a manufacturing method of the positive electrode active material of one embodiment of the present invention is described with reference to FIG. 6 and FIG. 7. In addition, FIG. 8 and FIG. 9 show another more specific example of the manufacturing method.

### <Step S11>

First, a halogen source such as a fluorine source or a chlorine source is prepared as materials of a mixture 902 as shown in Step S11 in FIG. 6. In addition, a lithium source is preferably prepared as well. An element A source may also be prepared. An example of using magnesium as the element A is described below.

As the fluorine source, a metal fluoride is preferably used. A fluoride of the metal such as the element A or lithium, which is preferably included in the positive electrode active material, is preferably used as the metal fluoride, in which case such a fluoride of the metal can be used as the fluorine source and the element A source or as the fluorine source and the lithium source. As the metal fluoride, for example, lithium fluoride, magnesium fluoride, sodium fluoride, potassium fluoride, or the like can be used. Among them, lithium fluoride, which has a relatively low melting point of 848° C., is preferable because it is easily melted in an annealing process described later. As the chlorine source, for example, lithium chloride, magnesium chloride, sodium chloride, or the like can be used. As the magnesium source, for example, magnesium fluoride, magnesium oxide, magnesium hydroxide, magnesium carbonate, or the like can be used, and a fluoride is particularly preferably used. As the sodium source, for example, sodium fluoride, sodium chloride, or the like can be used, and a fluoride is particularly preferably used. As the potassium source, for example, potassium fluoride or the like is preferably used. As the lithium source, for example, lithium fluoride, lithium carbonate, or the like can be used, and a fluoride is particularly preferably used. Thus, lithium fluoride can be used as the lithium source and as the fluorine source. Magnesium fluoride can be used as the fluorine source and as the magnesium source.

In this embodiment, lithium fluoride LiF is prepared as the fluorine source and the lithium source, and magnesium fluoride MgF₂ is prepared as the fluorine source and the magnesium source (Step S11 in FIG. 8 as a specific example of FIG. 6). When lithium fluoride LiF and magnesium fluoride MgF₂ are mixed so that LiF:MgF₂ is approximately 65:35 (molar ratio), the effect of reducing the melting point becomes the highest (Non-Patent Document 1). Thus, fluorine can be more easily introduced into a surface of a positive electrode active material 100C described later, a region in the vicinity thereof, a grain boundary and a region in the vicinity thereof, for example. However, if lithium fluoride is increased, lithium to be introduced into the positive electrode active material 100C described later becomes excessive, which might cause deterioration of cycle performance. Therefore, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF₂=x:1 (x=or a value close thereto 0.33). Note that in this specification and the like, the vicinity means a value greater than 0.9 times and smaller than 1.1 times a certain value.

In the case where sodium is used as the element A, for example, sodium fluoride or the like can be used as the sodium source. In the case where potassium is used as the element A, for example, sodium potassium or the like can be used as the potassium source.

In addition, in the case where the following mixing and grinding steps are performed by a wet process, a solvent is prepared. As the solvent, ketone such as acetone; alcohol such as ethanol or isopropanol; ether; dioxane; acetonitrile; N-methyl-2-pyrrolidone (NMP); or the like can be used. An aprotic solvent that hardly reacts with lithium is further preferably used. In this embodiment, acetone is used (see Step S11 in FIG. 6).

### <Step S12>

Next, the materials of the mixture 902 are mixed and ground (Step S12 in FIG. 6 and FIG. 8). Although the mixing can be performed by a dry process or a wet process, the wet process is preferable because the materials can be ground to the smaller size. For example, a ball mill, a bead mill, or the like can be used for the mixing. When the ball mill is used, a zirconia ball is preferably used as media, for example. The mixing step and the grinding step are preferably performed sufficiently to pulverize the mixture 902.

### <Step S13 and Step S14>

The materials mixed and ground in the above manner are collected (Step S13 in FIG. 6 and FIG. 8), whereby the mixture 902 is obtained (Step S14 in FIG. 6 and FIG. 8).

For example, the mixture 902 preferably has an average particle size (D50) of greater than or equal to 600 nm and less than or equal to 20 μm, further preferably greater than or equal to 1 μm and less than or equal to 10 μm. When mixed with a composite oxide including lithium, a transition metal, and oxygen in the later step, the mixture 902 pulverized to such a small size is easily attached to surfaces of composite oxide particles uniformly. The mixture 902 is preferably attached to the surfaces of the composite oxide particles uniformly because both a halogen and magnesium are easily distributed to the surface portion of the composite oxide particles after heating. When there is a region containing neither a halogen nor magnesium in the surface portion, the positive electrode active material might be less likely to have the above-described pseudo-spinel crystal structure in the charged state.

Next, the composite oxide including lithium, the transition metal, and oxygen is obtained through Step S21 to Step S25.

### <Step S21>

Next, as shown in Step S21 in FIG. 6, a lithium source and a transition metal source are prepared as materials of the composite oxide including lithium, the transition metal, and oxygen.

As the lithium source, for example, lithium carbonate, lithium fluoride, or the like can be used.

As the transition metal source, at least one of cobalt, manganese, and nickel can be used, for example.

In the case where the positive electrode active material has a layered rock-salt crystal structure, as the ratio of the materials, the mixture ratio of cobalt, manganese, and nickel with which the positive electrode active material can have a layered rock-salt crystal structure is used. In addition, aluminum may be added to the transition metal as long as the positive electrode active material can have the layered rock-salt crystal structure.

When manganese and cobalt are included in the positive electrode active material of one embodiment of the present invention, for example, the number of manganese atoms included in a manganese source is preferably larger than the number of cobalt atoms included in a cobalt source in the manufacture of the positive electrode active material of one embodiment of the present invention. For example, the number of the manganese atoms is preferably greater than or equal to the number of the cobalt atoms and less than 3 times, further preferably greater than or equal to 1.1 times and less than or equal to 2.2 times, still further preferably greater than or equal to 1.3 times and less than or equal to 1.8 times the number of the cobalt atoms.

When manganese and nickel are included in the positive electrode active material of one embodiment of the present invention, for example, the number of the manganese atoms included in the manganese source is preferably greater than or equal to 0.1 times and less than or equal to twice, further preferably greater than or equal to 0.12 times and less than the number of nickel atoms included in the nickel source in the manufacture of the positive electrode active material of one embodiment of the present invention.

As the transition metal source, oxide or hydroxide of the transition metal, or the like can be used. As the cobalt source, for example, cobalt oxide, cobalt hydroxide, or the like can be used. As the manganese source, manganese oxide, manganese hydroxide, or the like can be used. As the nickel source, nickel oxide, nickel hydroxide, or the like can be used. As an aluminum source, aluminum oxide, aluminum hydroxide, or the like can be used.

### <Step S22>

Next, the lithium source and the transition metal source are mixed (Step S22 in FIG. 6). The mixing can be performed by a dry process or a wet process. For example, a ball mill, a bead mill, or the like can be used for the mixing. When the ball mill is used, a zirconia ball is preferably used as media, for example.

### <Step S23>

Next, the materials mixed in the above manner are heated. This step is sometimes referred to as baking or first heating to distinguish this step from a heating step performed later. The heating is preferably performed at higher than or equal to 700° C. and lower than 1100° C., further preferably at higher than or equal to 750° C. and lower than or equal to 950° C., still further preferably at approximately 850° C. Excessively low temperature might result in insufficient decomposition and melting of starting materials. By contrast, excessively high temperature might cause a defect due to excessive reduction of the transition metal, evaporation of lithium, or the like. In particular, since nickel is easily reduced, a defect in which nickel has a valence of two might be caused.

The heating time is preferably longer than or equal to 2 hours and shorter than or equal to 20 hours. Baking is performed preferably in an atmosphere containing oxygen, further preferably in an atmosphere with little water, such as dry air (e.g., a dew point is lower than or equal to −50° C., further preferably lower than or equal to −100° C.). For example, it is preferable that the heating be performed at 850° C. for 10 hours, the temperature rise be 200° C./h, and the flow rate of a dry atmosphere be 5 to 10 L/min. After that, the heated materials can be cooled to room temperature. The temperature decreasing time from the specified temperature to room temperature is preferably longer than or equal to 10 hours and shorter than or equal to 50 hours, for example.

Note that the cooling to room temperature in Step S23 is not essential. As long as later steps of Step S24, Step S25, and Step S31 to Step S34 are performed without problems, the cooling may be performed at a temperature higher than room temperature.

Note that the metals contained in the positive electrode active material may be introduced in Step S22 and Step S23 described above, and some of the metals can be introduced in Step S41 to Step S46 described later. More specifically, a metal M1 (M1 is one or more elements selected from cobalt, manganese, nickel, and aluminum) is introduced in Step S22 and Step S23, and a metal M2 (M2 is one or more elements selected from manganese, nickel, and aluminum, for example) is introduced in Step S41 to Step S46. When the step of introducing the metal M1 and the step of introducing the metal M2 are separately performed in such a manner, the profiles in the depth direction of the metals can be made different from each other in some cases. For example, the concentration of the metal M2 in the surface portion of a particle can be higher than that in the inner portion of the particle. Furthermore, with the number of atoms of the metal M1 as a reference, the ratio of the number of atoms of the metal M2 with respect to the reference can be higher in the surface portion than in the inner portion.

For the positive electrode active material of one embodiment of the present invention, cobalt is preferably selected as the metal M1 and nickel and aluminum are preferably selected as the metal M2.

### <Step S24 and Step S25>

The materials baked in the above manner are collected (Step S24 in FIG. 6), whereby the composite oxide including lithium, the transition metal, and oxygen is obtained as the positive electrode active material 100C (Step S25 in FIG. 6). Specifically, lithium cobalt oxide, lithium manganese oxide, lithium nickel oxide, lithium cobalt oxide in which manganese is substituted for part of cobalt, or lithium nickel-cobalt-manganese oxide is obtained.

A composite oxide including lithium, a transition metal, and oxygen that is synthesized in advance may be used as Step S25 (see FIG. 8). In this case, Step S21 to Step S24 can be skipped.

In the case where the composite oxide including lithium, the transition metal, and oxygen that is synthesized in advance is used, a composite oxide with few impurities is preferably used. In this specification and the like, lithium, cobalt, nickel, manganese, aluminum, and oxygen are the main components of the composite oxide including lithium, the transition metal, and oxygen and the positive electrode active material, and elements other than the main components are regarded as impurities. For example, when analyzed by a glow discharge mass spectroscopy method, the total impurity element concentration is preferably less than or equal to 10,000 ppm wt, further preferably less than or equal to 5,000 ppm wt. In particular, the total impurity concentration of transition metals such as titanium and arsenic is preferably less than or equal to 3,000 ppm wt, further preferably less than or equal to 1,500 ppm wt.

In this embodiment, an NCM particle produced by MTI Corporation is used as nickel-cobalt-lithium manganate (hereinafter, NCM) synthesized in advance. The mean particle size (D50) of this approximately ranges from 10 μm to 14 μm. The ratio of cobalt atoms to nickel atoms is approximately 0.4, and the ratio of manganese atoms to nickel atoms is approximately 0.6.

The composite oxide including lithium, the transition metal, and oxygen in Step S25 preferably has a layered rock-salt crystal structure with few defects and distortions. Therefore, the composite oxide is preferably a composite oxide that includes few impurities. In the case where the composite oxide including lithium, the transition metal, and oxygen includes a lot of impurities, the crystal structure is highly likely to have a lot of defects or distortions.

Here, the positive electrode active material 100C includes a crack in some cases. The crack is generated in any of Step S21 to Step S25 or in a plurality of steps. For example, the crack is generated in the baking step of Step S23. The number of generated cracks might vary depending on conditions such as the baking temperature, the rate of increasing or decreasing temperature in baking, and the like. Furthermore, the crack might be generated in the steps of mixing, grinding, and the like, for example.

### <Step S31>

Next, the mixture 902 and the composite oxide including lithium, the transition metal, and oxygen are mixed (Step S31 in FIG. 6 and FIG. 8).

When the mixture 902 includes the element A, the ratio of the number TM of transition metal atoms in the composite oxide including lithium, the transition metal, and oxygen to the number MgMix1 of atoms of the element A included in the mixture 902 is preferably TM:MgMix1=1:y (0.0005≤y≤0.02), further preferably TM:MgMix1=1:y (0.001≤y≤0.01), still further preferably approximately TM:MgMix1=1:0.005.

The number of fluorine atoms included in the mixture 902 is preferably greater than or equal to 0.001 times and less than or equal to 0.02 times the number of the transition metal atoms in the composite oxide including lithium, the transition metal, and oxygen.

The condition of the mixing in Step S31 is preferably milder than that of the mixing in Step S12 not to damage the particles of the composite oxide. For example, a condition with a lower rotation frequency or shorter time than the mixing in Step S12 is preferable. In addition, it can be said that the dry process has a milder condition than the wet process. For example, a ball mill, a bead mill, or the like can be used for the mixing. When the ball mill is used, a zirconia ball is preferably used as media, for example.

### <Step S32 and Step S33>

The materials mixed in the above manner are collected (Step S32 in FIG. 6 and FIG. 8), whereby the mixture 903 is obtained (Step S33 in FIG. 6 and FIG. 8).

Note that this embodiment describes a method for adding the mixture of lithium fluoride and magnesium fluoride to NCM with few impurities; however, one embodiment of the present invention is not limited thereto. Mixture obtained through baking after addition of a magnesium source and a fluorine source to the starting material of NCM may be used instead of the mixture 903 in Step S33. In that case, there is no need to separate steps Step S11 to Step S14 and steps Step S21 to Step S25, which is simple and productive.

Alternatively, NCM to which magnesium and fluorine are added in advance may be used. When NCM to which magnesium and fluorine are added is used, the process can be simpler because the steps up to Step S32 can be omitted.

In addition, a magnesium source and a fluorine source may be further added to the NCM to which magnesium and fluorine are added in advance.

### <Step S34>

Next, the mixture 903 is heated. This step can be referred to as annealing or second heating to distinguish this step from the heating step performed before.

The annealing is preferably performed at an appropriate temperature for an appropriate time. The appropriate temperature and time depend on the conditions such as the particle size and the composition of the composite oxide including lithium, the transition metal, and oxygen in Step S25. In the case where the particle size is small, the annealing is preferably performed at a lower temperature or for a shorter time than the case where the particle size is large, in some cases.

The annealing temperature is preferably, for example, higher than or equal to 500° C. and lower than or equal to 950° C., further preferably higher than or equal to 600° C. and lower than 900° C., still further preferably approximately 700° C. The annealing time is preferably longer than or equal to one hour and shorter than or equal to 100 hours, for example. Excessively high temperature might cause a defect due to excessive reduction of the transition metal, evaporation of lithium, or the like. In particular, since nickel is easily reduced, a defect in which nickel has a valence of two might be caused.

The temperature decreasing time after the annealing is, for example, preferably longer than or equal to 10 hours and shorter than or equal to 50 hours.

It is considered that when the mixture 903 is annealed, a material having a low melting point (e.g., lithium fluoride, which has a melting point of 848° C.) in the mixture 902 is melted first and distributed to the surface portion of the composite oxide particle. Next, the existence of the melted material decreases the melting points of other materials, probably resulting in melting of the other materials. For example, magnesium fluoride (melting point: 1263° C.) is probably melted and distributed to the surface portion of the composite oxide particle.

Then, the elements that are included in the mixture 902 and are distributed to the surface portion probably form a solid solution in the composite oxide including lithium, the transition metal, and oxygen.

The elements included in the mixture 902 diffuse faster in the surface portion and the vicinity of the grain boundary than inside the composite oxide particles. Therefore, the concentrations of magnesium and a halogen in the surface portion and the vicinity of the grain boundary are higher than those of magnesium and a halogen inside the composite oxide particles. As described later, the higher the magnesium concentration in the surface portion and the vicinity of the grain boundary is, the more effectively the change in the crystal structure can be suppressed.

### <Step S35 and Step S36>

The material annealed in the above manner is collected (Step S35 in FIG. 6 and FIG. 8), whereby a positive electrode active material 100A_1 is obtained (Step S36 in FIG. 6 and FIG. 8).

### <Step S51>

Next, a compound including the element X is prepared as a first raw material 901 (Step S51 in FIG. 7 and FIG. 9).

The first raw material 901 may be ground in Step S51. For example, a ball mill, a bead mill, or the like can be used for the grinding. The powder obtained after the grinding may be classified using a sieve.

The first raw material 901 is a compound including the element X, and phosphorus can be used as the element X The first raw material 901 is preferably a compound having a bond between the element X and oxygen.

As the first raw material 901, for example, a phosphate compound can be used. As the phosphate compound, a phosphate compound including an element D can be used. The element D is one or more elements selected from lithium, sodium, potassium, magnesium, zinc, cobalt, iron, manganese, and aluminum. A phosphate compound including hydrogen in addition to the element D can be used. An ammonium phosphate, or an ammonium salt containing the element D can also be used as the phosphate compound.

Examples of the phosphate compound include lithium phosphate, sodium phosphate, potassium phosphate, magnesium phosphate, zinc phosphate, aluminum phosphate, ammonium phosphate, lithium dihydrogen phosphate, ammonium dihydrogen phosphate, magnesium hydrogen phosphate, and lithium cobalt phosphate. As the positive electrode active material, lithium phosphate or magnesium phosphate is particularly preferably used.

In this embodiment, lithium phosphate is used as the first raw material 901 (Step S51 in FIG. 7 and FIG. 9).

### <Step S52>

Next, the first raw material 901 obtained in Step S51 and the positive electrode active material 100A_1 obtained in Step S36 are mixed (Step S52 in FIG. 7 and FIG. 9). It is preferable to mix the first raw material 901 at 0.01 mol to 0.1 mol inclusive, further preferably at 0.02 mol to 0.08 mol inclusive with respect to 1 mol of the positive electrode active material 100C obtained in Step S25. For example, a ball mill, a bead mill, or the like can be used for the mixing. The powder obtained after the mixing may be classified using a sieve.

### <Step S53>

Next, the materials mixed in the above are heated (Step S53 in FIG. 7 and FIG. 9). In the formation of the positive electrode active material, this step is not necessarily performed in some cases. In the case of performing heating, the heating is preferably performed at higher than or equal to 300° C. and lower than 1200° C., further preferably at higher than or equal to 550° C. and lower than or equal to 950° C., still further preferably at approximately 750° C. Excessively low temperature might result in insufficient decomposition and melting of starting materials. By contrast, excessively high temperature might cause a defect due to excessive reduction of the transition metal, evaporation of lithium, or the like.

By the heating, a reaction product of the positive electrode active material 100A_1 and the first raw material 901 is generated in some cases.

The heating time is preferably longer than or equal to 2 hours and shorter than or equal to 60 hours. Baking is preferably performed in an atmosphere with little moisture, such as dry air (e.g., a dew point is lower than or equal to −50° C., further preferably lower than or equal to −100° C.). For example, it is preferable that the heating be performed at 1000° C. for 10 hours, the temperature rise be 200° C./h, and the flow rate of a dry atmosphere be 10 L/min. After that, the heated materials can be cooled to room temperature. The temperature decreasing time from the specified temperature to room temperature is preferably longer than or equal to 10 hours and shorter than or equal to 50 hours, for example.

Note that the cooling to room temperature in Step S53 is not essential. As long as later Step S54 is performed without problems, it is possible to perform cooling to a temperature higher than room temperature.

### <Step S54>

The materials baked in the above are collected (Step S54 in FIG. 7 and FIG. 9), whereby a positive electrode active material 100A_3 containing the element D is obtained.

The description of the positive electrode active material described with reference to FIG. 1 to FIG. 3 and the like can be referred to for the positive electrode active material 100A_1 and the positive electrode active material 100A_3.

This embodiment can be implemented in appropriate combination with the other embodiments.

### Embodiment 2

In this embodiment, examples of materials that can be used for a secondary battery containing the positive electrode active material described in the above embodiment are described. In this embodiment, a secondary battery in which a positive electrode, a negative electrode, and an electrolyte solution are wrapped in an exterior body is described as an example.

### [Positive Electrode]

The positive electrode includes a positive electrode active material layer and a positive electrode current collector.

### <Positive Electrode Active Material Layer>

The positive electrode active material layer contains at least a positive electrode active material. The positive electrode active material layer may contain, in addition to the positive electrode active material, other materials such as a coating film of the active material surface, a conductive additive, and a binder.

As the positive electrode active material, the positive electrode active material described in the above embodiment can be used. A secondary battery including the positive electrode active material described in the above embodiment can have high capacity and excellent cycle performance.

Examples of the conductive additive include a carbon material, a metal material, and a conductive ceramic material. A fiber material may be used as the conductive additive. The content of the conductive additive in the active material layer is preferably greater than or equal to 1 wt % and less than or equal to 10 wt %, further preferably greater than or equal to 1 wt % and less than or equal to 5 wt %.

A network for electric conduction can be formed in the active material layer by the conductive additive. The conductive additive also allows the maintenance of a path for electric conduction between the positive electrode active material particles. The addition of the conductive additive to the active material layer increases the electric conductivity of the active material layer.

Examples of the conductive additive include natural graphite, artificial graphite such as mesocarbon microbeads, and carbon fiber. As carbon fiber, mesophase pitch-based carbon fiber and isotropic pitch-based carbon fiber can be used. Furthermore, as carbon fiber, carbon nanofiber and carbon nanotube can be used. Carbon nanotube can be formed by, for example, a vapor deposition method. Other examples of the conductive additive include carbon materials such as carbon black (e.g., acetylene black (AB)), graphite (black lead) particles, graphene, and fullerene. For example, metal powder or metal fibers of copper, nickel, aluminum, silver, gold, or the like, a conductive ceramic material, or the like can be used.

A graphene compound may be used as the conductive additive.

A graphene compound has excellent electrical characteristics of high conductivity and excellent physical properties of high flexibility and high mechanical strength in some cases. Furthermore, a graphene compound has a planar shape. A graphene compound enables low-resistance surface contact. Furthermore, a graphene compound has extremely high conductivity even with a small thickness in some cases and thus allows a conductive path to be formed in an active material layer efficiently even with a small amount. Thus, a graphene compound is preferably used as the conductive additive, in which case the area where the active material and the conductive additive are in contact with each other can be increased. The graphene compound serving as the conductive additive is preferably formed with a spray dry apparatus as a coating film to cover the entire surface of the active material, in which case the electrical resistance can be reduced in some cases. Here, it is particularly preferable to use, for example, graphene, multilayer graphene, or RGO as a graphene compound. Note that RGO refers to a compound obtained by reducing graphene oxide (GO), for example.

In the case where an active material with a small particle size (e.g., 1 μm or less) is used, the specific surface area of the active material is large and thus more conductive paths for the active material particles are needed. Thus, the amount of conductive additive tends to increase and the carried amount of active material tends to decrease relatively. When the carried amount of active material decreases, the capacity of the secondary battery also decreases. In such a case, a graphene compound that can efficiently form a conductive path even with a small amount is particularly preferably used as the conductive additive because the carried amount of active material does not decrease.

A cross-sectional structure example of an active material layer 200 containing a graphene compound as a conductive additive is described below.

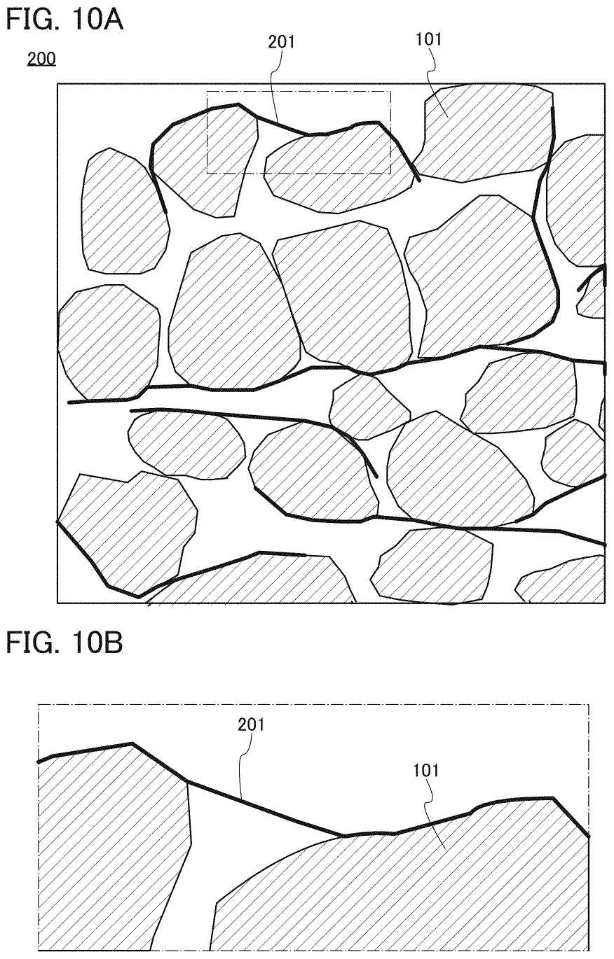

FIG. 10A is a longitudinal cross-sectional view of the active material layer 200. The active material layer 200 includes particles of a positive electrode active material 101, a graphene compound 201 serving as a conductive additive, and a binder (not illustrated). Here, graphene or multilayer graphene may be used as the graphene compound 201, for example. The graphene compound 201 preferably has a sheet-like shape. The graphene compound 201 may have a sheet-like shape formed of a plurality of sheets of multilayer graphene and/or a plurality of sheets of graphene that partly overlap with each other.

The longitudinal cross section of the active material layer 200 in FIG. 10B shows substantially uniform dispersion of the sheet-like graphene compounds 201 in the active material layer 200. The graphene compounds 201 are schematically shown by thick lines in FIG. 10B but are actually thin films each having a thickness corresponding to the thickness of a single layer or a multi-layer of carbon molecules. The plurality of graphene compounds 201 are formed to partly coat or adhere to the surfaces of the plurality of particles of the positive electrode active material 101, so that the graphene compounds 201 make surface contact with the particles of the positive electrode active material 101.

Here, the plurality of graphene compounds are bonded to each other to form a net-like graphene compound sheet (hereinafter, referred to as a graphene compound net or a graphene net). The graphene net covering the active material can function as a binder for bonding active materials. The amount of binder can thus be reduced, or the binder does not have to be used. This can increase the proportion of the active material in the electrode volume or weight. That is to say, the capacity of the secondary battery can be increased.

Here, it is preferable to perform reduction after a layer to be the active material layer 200 is formed in such a manner that graphene oxide is used as the graphene compound 201 and mixed with an active material. When graphene oxide with extremely high dispersibility in a polar solvent is used for the formation of the graphene compounds 201, the graphene compounds 201 can be substantially uniformly dispersed in the active material layer 200. The solvent is removed by volatilization from a dispersion medium in which graphene oxide is uniformly dispersed, and the graphene oxide is reduced; hence, the graphene compounds 201 remaining in the active material layer 200 partly overlap with each other and are dispersed such that surface contact is made, thereby forming a three-dimensional conduction path. Note that graphene oxide can be reduced either by heat treatment or with the use of a reducing agent, for example.

Unlike conductive additive particles that make point contact with an active material, such as acetylene black, the graphene compound 201 is capable of making low-resistance surface contact; accordingly, the electrical conduction between the particles of the positive electrode active material 101 and the graphene compounds 201 can be improved with a smaller amount of the graphene compound 201 than that of a normal conductive additive. This increases the proportion of the particles of the positive electrode active material 101 in the active material layer 200, resulting in increased discharge capacity of the secondary battery.

With a spray dry apparatus, a graphene compound serving as a conductive additive as a coating film can be formed to cover the entire surface of the active material in advance and a conductive path can be formed between the active materials using the graphene compound.

As the binder, a rubber material such as styrene-butadiene rubber (SBR), styrene-isoprene-styrene rubber, acrylonitrile-butadiene rubber, butadiene rubber, or ethylene-propylene-diene copolymer can be used, for example. Fluororubber can be used as the binder.

For the binder, for example, water-soluble polymers are preferably used. As the water-soluble polymers, for example, a polysaccharide can be used. As the polysaccharide, for example, a cellulose derivative such as carboxymethyl cellulose (CMC), methyl cellulose, ethyl cellulose, hydroxypropyl cellulose, diacetyl cellulose, and regenerated cellulose or starch can be used. It is further preferred that such water-soluble polymers be used in combination with any of the above rubber materials.

Alternatively, as the binder, a material such as polystyrene, poly(methyl acrylate), poly(methyl methacrylate) (polymethyl methacrylate, PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, a rubber material or the like is preferably mixed with a material having a significant viscosity modifying effect, for example. As a material having a significant viscosity modifying effect, for example, a water-soluble polymer is preferably used. An example of a water-soluble polymer having an especially significant viscosity modifying effect is the above-mentioned polysaccharide; for example, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and accordingly, easily exerts an effect as a viscosity modifier. The high solubility can also increase the dispersibility of an active material and other components in the formation of slurry for an electrode. In this specification, cellulose and a cellulose derivative used as a binder of an electrode include salts thereof.

The water-soluble polymers stabilize viscosity by being dissolved in water and allow stable dispersion of the active material and another material combined as a binder, such as styrene-butadiene rubber, in an aqueous solution. Furthermore, a water-soluble polymer is expected to be easily and stably adsorbed to an active material surface because it has a functional group. Many cellulose derivatives such as carboxymethyl cellulose have functional groups such as a hydroxyl group and a carboxyl group. Because of functional groups, polymers are expected to interact with each other and cover an active material surface in a large area.

In the case where the binder covering or being in contact with the active material surface forms a film, the film is expected to serve as a passivation film to suppress the decomposition of the electrolyte solution. Here, the passivation film refers to a film without electronic conductivity or a film with extremely low electric conductivity, and can suppress the decomposition of an electrolyte solution at a potential at which a battery reaction occurs in the case where the passivation film is formed on the active material surface, for example. It is preferred that the passivation film can conduct lithium ions while suppressing electric conduction.

### <Positive Electrode Current Collector>

The positive electrode current collector can be formed using a material that has high conductivity, such as a metal like stainless steel, gold, platinum, aluminum, and titanium, or an alloy thereof. It is preferred that a material used for the positive electrode current collector not dissolve at the potential of the positive electrode. The positive electrode current collector can be formed using an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have any of various shapes including a foil-like shape, a plate-like shape (sheet-like shape), a net-like shape, a punching-metal shape, and an expanded-metal shape. The current collector preferably has a thickness of greater than or equal to 5 μm and less than or equal to 30 μm.

### [Negative Electrode]

The negative electrode includes a negative electrode active material layer and a negative electrode current collector. The negative electrode active material layer may contain a conductive additive and a binder.

### <Negative Electrode Active Material>

As a negative electrode active material, for example, an alloy-based material or a carbon-based material can be used.

For the negative electrode active material, an element that enables charge-discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. A compound including any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge-discharge reactions by an alloying reaction and a dealloying reaction with lithium and a compound including the element, for example, may be referred to as an alloy-based material.

In this specification and the like, SiO refers, for example, to silicon monoxide or can be expressed as SiOₓ. Here, x preferably has an approximate value of 1. For example, x is preferably 0.2 or more and 1.5 or less, further preferably 0.3 or more and 1.2 or less.

As the carbon-based material, graphite, graphitizing carbon (soft carbon), non-graphitizing carbon (hard carbon), carbon nanotube, graphene, carbon black, and the like may be used.

Examples of graphite include artificial graphite and natural graphite. Examples of artificial graphite include meso-carbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it is relatively easy to have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into graphite (when a lithium-graphite intercalation compound is formed). For this reason, a lithium-ion secondary battery can have a high operating voltage. In addition, graphite is preferred because of its advantages such as a relatively high capacity per unit volume, relatively small volume expansion, low cost, and higher level of safety than that of a lithium metal.

For the negative electrode active material, oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

For the negative electrode active material, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material which does not contain lithium ions, such as V₂O₅ or Cr₃O₈. Note that in the case of using a material containing lithium ions as a positive electrode active material, the nitride containing lithium and a transition metal can be used for the negative electrode active material by extracting the lithium ions contained in the positive electrode active material in advance.

A material that causes a conversion reaction can be used for the negative electrode active material; for example, a transition metal oxide that does not form an alloy with lithium, such as cobalt oxide (CoO), nickel oxide (NiO), and iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those of the conductive additive and the binder that can be included in the positive electrode active material layer can be used.

### <Negative Electrode Current Collector>

For the negative electrode current collector, a material similar to that of the positive electrode current collector can be used. Note that a material which is not alloyed with carrier ions such as lithium is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

The use of one or more ionic liquids (room temperature molten salts) that are less likely to burn and volatize as the solvent of the electrolyte solution can prevent a secondary battery from exploding or catching fire even when the secondary battery internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂Bi₂Cl₁₂, LiCF₃SO₃, LiC₄F₉SO₃, LiC(CF₃SO₂)₃, LiC(C₂F₅S₀₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination in an appropriate ratio.

The electrolyte solution used for a secondary battery is preferably highly purified and contains small numbers of dust particles and elements other than the constituent elements of the electrolyte solution (hereinafter, also simply referred to as impurities). Specifically, the weight ratio of impurities to the electrolyte solution is less than or equal to 1%, preferably less than or equal to 0.1%, and further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of a material to be added in the whole solvent is, for example, higher than or equal to 0.1 wt % and lower than or equal to 5 wt %.

A polymer gelled electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP) can be used. The formed polymer may be porous.

Instead of the electrolyte solution, a solid electrolyte including an inorganic material such as a sulfide-based inorganic material or an oxide-based inorganic material, or a solid electrolyte including a high-molecular material such as a PEO (polyethylene oxide)-based high-molecular material may be used. When the solid electrolyte is used, a separator and a spacer are not necessary. Furthermore, the battery can be entirely solidified; therefore, there is no possibility of liquid leakage and thus the safety of the battery is dramatically increased.

### [Separator]

The secondary battery preferably includes a separator. As the separator, for example, paper; nonwoven fabric; glass fiber; ceramics; or synthetic fiber containing nylon (polyamide), vinylon (polyvinyl alcohol-based fiber), polyester, acrylic, polyolefin, or polyurethane can be used. The separator is preferably formed to have an envelope-like shape to wrap one of the positive electrode and the negative electrode.

The separator may have a multilayer structure. For example, an organic material film such as polypropylene or polyethylene can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

Deterioration of the separator in charge and discharge at high voltage can be suppressed and thus the reliability of the secondary battery can be improved because oxidation resistance is improved when the separator is coated with the ceramic-based material. In addition, when the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. A surface of the polypropylene film that is in contact with the positive electrode may be coated with the mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. An exterior body in the form of a film can also be used. As the film, for example, a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used.

### [Charge and Discharge Methods]

The secondary battery can be charged and discharged in the following manner, for example.

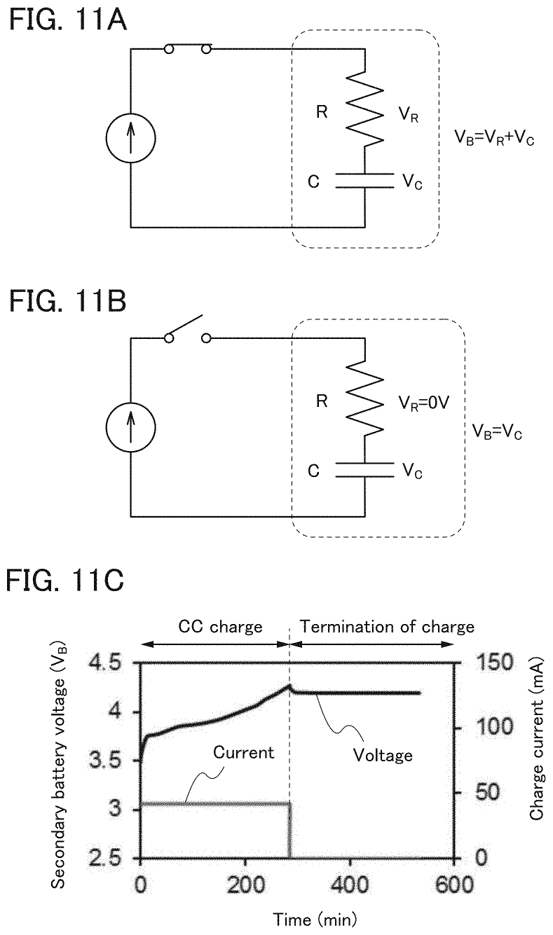

First, CC charge, which is one of charge methods, is described. CC charge is a charge method in which a constant current is made to flow to a secondary battery in the whole charge period and charge is terminated when the voltage reaches a predetermined voltage. The secondary battery is assumed to be an equivalent circuit with internal resistance R and secondary battery capacitance C as illustrated in FIG. 11A. In that case, a secondary battery voltage V_{B} is the sum of a voltage V_{R} applied to the internal resistance R and a voltage V_{C} applied to the secondary battery capacitance C.

While the CC charge is performed, a switch is on as illustrated in FIG. 11A, so that a constant current I flows to the secondary battery. During the period, the current I is constant; thus, in accordance with the Ohm's law (V_{R}=R×I), the voltage V_{R} applied to the internal resistance R is also constant. By contrast, the voltage V_{C} applied to the secondary battery capacitance C increases over time. Accordingly, the secondary battery voltage V_{B} increases over time.

When the secondary battery voltage V_{B} reaches a predetermined voltage, e.g., 4.3 V, the charge is terminated. On termination of the CC charge, the switch is turned off as illustrated in FIG. 11B, and the current I becomes 0. Thus, the voltage V_{R} applied to the internal resistance R becomes 0 V. Consequently, the secondary battery voltage V_{B} is decreased.

FIG. 11C shows an example of the secondary battery voltage V_{B} and charge current during a period in which the CC charge is performed and after the CC charge is terminated. The secondary battery voltage V_{B} increases while the CC charge is performed, and slightly decreases after the CC charge is terminated.

Next, CCCV charge, which is a charge method different from the above-described method, is described. CCCV charge is a charge method in which CC charge is performed until the voltage reaches a predetermined voltage and then CV (constant voltage) charge is performed until the amount of current flow becomes small, specifically, a termination current value.

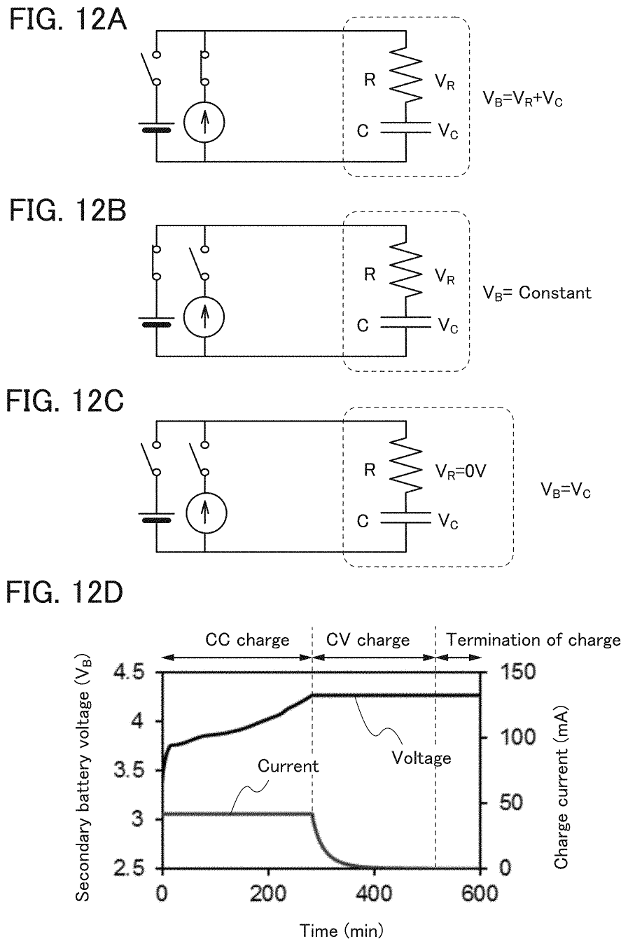

While the CC charge is performed, a switch of a constant current power source is on and a switch of a constant voltage power source is off as illustrated in FIG. 12A, so that the constant current I flows to the secondary battery. During the period, the current I is constant; thus, in accordance with the Ohm's law (V_{R}=R×I), the voltage V_{R} applied to the internal resistance R is also constant. By contrast, the voltage V_{C} applied to the secondary battery capacitance C increases over time. Accordingly, the secondary battery voltage V_{B} increases over time.

When the secondary battery voltage V_{B} reaches a predetermined voltage, e.g., 4.3 V, switching is performed from the CC charge to the CV charge. While the CV charge is performed, the switch of the constant voltage power source is on and the switch of the constant current power source is off as illustrated in FIG. 12B; thus, the secondary battery voltage V_{B} is constant. By contrast, the voltage V_{C} applied to the secondary battery capacitance C increases over time. Since V_{B}=V_{R} V_{C} is satisfied, the voltage V_{R} applied to the internal resistance R decreases over time.

As the voltage V_{R} applied to the internal resistance R decreases, the current I flowing to the secondary battery also decreases in accordance with the Ohm's law (V_{R}=R×I).

When the current I flowing to the secondary battery becomes a predetermined current, e.g., approximately 0.01 C, charge is terminated. On termination of the CCCV charge, all the switches are turned off as illustrated in FIG. 12C, so that the current I becomes 0. Thus, the voltage V_{R} applied to the internal resistance R becomes 0 V. However, the voltage V_{R} applied to the internal resistance R becomes sufficiently small by the CV charge; thus, even when a voltage drop no longer occurs in the internal resistance R, the secondary battery voltage V_{B} hardly decreases.

FIG. 12D shows an example of the secondary battery voltage V_{B} and charge current while the CCCV charge is performed and after the CCCV charge is terminated. Even after the CCCV charge is terminated, the secondary battery voltage V_{B} hardly decreases.

Next, CC discharge, which is one of discharge methods, is described. CC discharge is a discharge method in which a constant current is made to flow from the secondary battery in the whole discharge period, and discharge is terminated when the secondary battery voltage V_{B} reaches a predetermined voltage, e.g., 2.5 V.

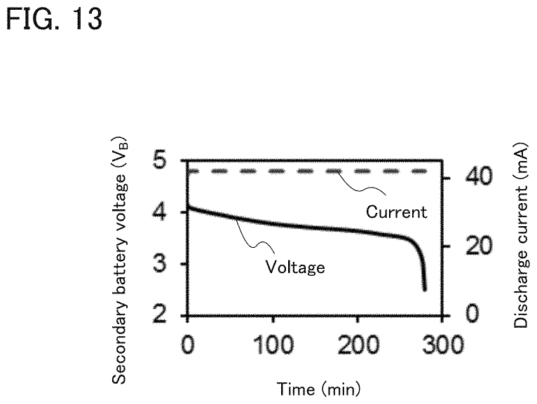

FIG. 13B shows an example of the secondary battery voltage V_{B} and discharge current while the CC discharge is performed. As discharge proceeds, the secondary battery voltage V_{B} decreases.

Next, a discharge rate and a charge rate are described. The discharge rate refers to the relative ratio of discharge current to battery capacity and is expressed in a unit C. A current of approximately 1 C in a battery with a rated capacity X (Ah) is X(A). The case where discharge is performed at a current of 2X(A) is rephrased as follows: discharge is performed at 2 C. The case where discharge is performed at a current of X/5(A) is rephrased as follows: discharge is performed at 0.2 C. Similarly, the case where charge is performed at a current of 2X(A) is rephrased as follows: charge is performed at 2 C, and the case where charge is performed at a current of X/5(A) is rephrased as follows: charge is performed at 0.2 C.

### Embodiment 3

In this embodiment, examples of a shape of a secondary battery containing the positive electrode active material described in the above embodiment are described. For the materials used for the secondary battery described in this embodiment, refer to the description of the above embodiment.

### [Coin-Type Secondary Battery]

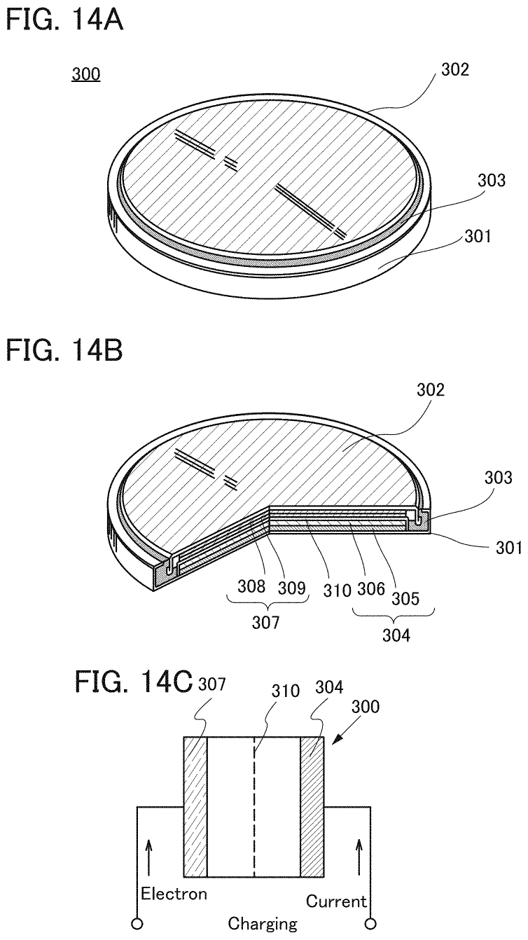

First, an example of a coin-type secondary battery is described. FIG. 14A is an external view of a coin-type (single-layer flat type) secondary battery, and FIG. 14B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are immersed in the electrolyte solution. Then, as illustrated in FIG. 14B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type secondary battery 300 can be manufactured.

When the positive electrode active material described in the above embodiment is used in the positive electrode 304, the coin-type secondary battery 300 with high capacity and excellent cycle performance can be obtained.

Here, a current flow in charge a secondary battery is described with reference to FIG. 14C. When a secondary battery using lithium is regarded as a closed circuit, lithium ions transfer and a current flows in the same direction. Note that in the secondary battery using lithium, an anode and a cathode change places in charge and discharge, and an oxidation reaction and a reduction reaction occur on the corresponding sides; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charge current is supplied. The use of the terms “anode” and “cathode” related to an oxidation reaction and a reduction reaction might cause confusion because the anode and the cathode change places at the time of charge and discharge. Thus, the terms “anode” and “cathode” are not used in this specification. If the term “anode” or “cathode” is used, it should be mentioned that the anode or the cathode is which of the one at the time of charge or the one at the time of discharge and corresponds to which of a positive (plus) electrode or a negative (minus) electrode.

Two terminals in FIG. 14C are connected to a charger, and the secondary battery 300 is charged. As the charge of the secondary battery 300 proceeds, a potential difference between electrodes increases.

### [Cylindrical Secondary Battery]

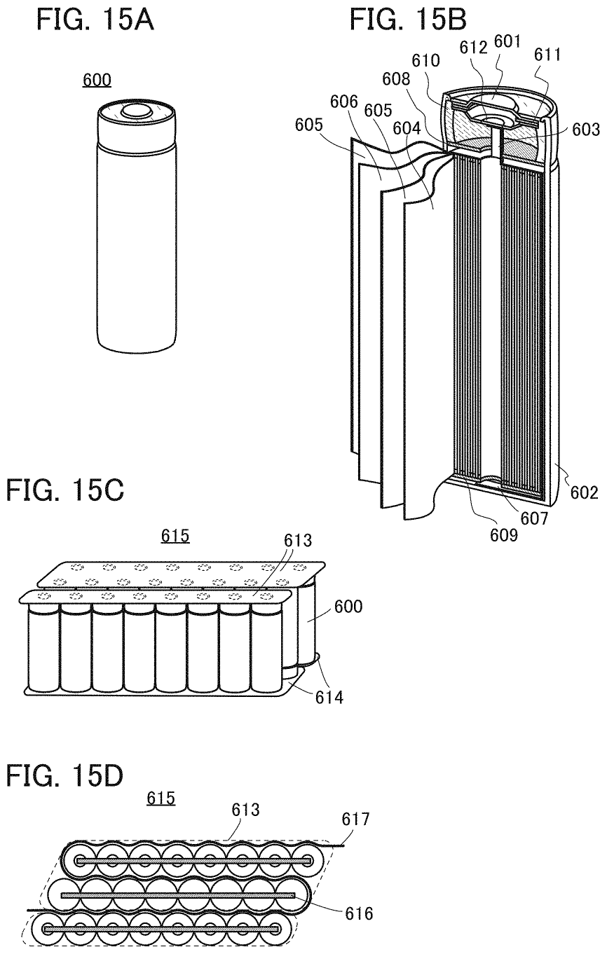

Next, an example of a cylindrical secondary battery is described with reference to FIG. 15. FIG. 15A illustrates an external view of a secondary battery 600. FIG. 15B is a schematic cross-sectional view of the cylindrical secondary battery 600. The cylindrical secondary battery 600 includes, as illustrated in FIG. 15B, a positive electrode cap (battery lid) 601 on the top surface and a battery can (outer can) 602 on the side and bottom surfaces. The positive electrode cap and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte solution that is similar to that of the coin-type secondary battery can be used.

Since the positive electrode and the negative electrode of the cylindrical storage battery are wound, active materials are preferably formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramic can be used for the PTC element.

As illustrated in FIG. 15C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 15D is a top view of the module 615. The conductive plate 613 is shown by a dotted line for clarity of the drawing. As illustrated in FIG. 15D, the module 615 may include a wiring 616 electrically connecting the plurality of secondary batteries 600 with each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be influenced by the outside temperature. A heating medium included in the temperature control device 617 preferably has an insulating property and incombustibility.

When the positive electrode active material described in the above embodiment is used in the positive electrode 604, the cylindrical secondary battery 600 with high capacity and excellent cycle performance can be obtained.

### [Structure Examples of Secondary Battery]

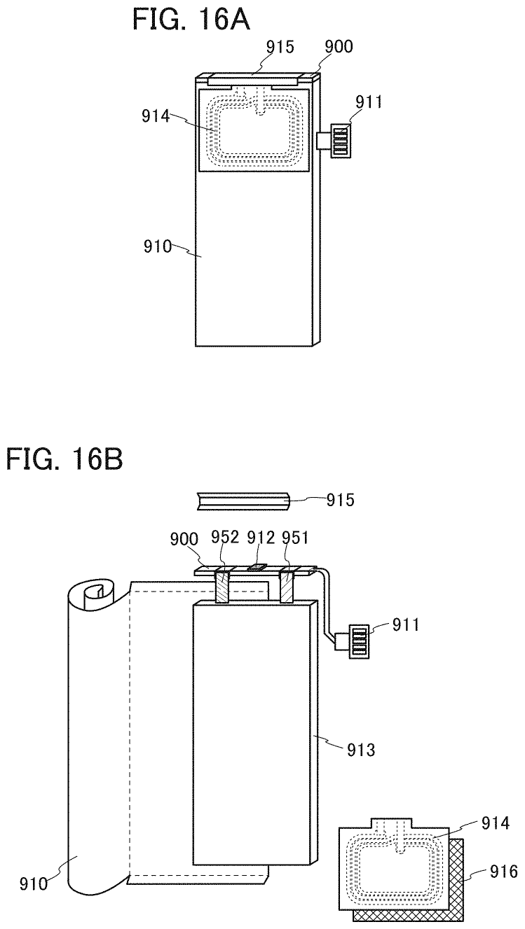

Other structure examples of secondary batteries are described with reference to FIG. 16 to FIG. 20.

FIG. 16A and FIG. 16B are external views of a battery pack. The battery pack includes a circuit board 900 and a secondary battery 913. A label 910 is attached to the secondary battery 913. In addition, as illustrated in FIG. 16B, the secondary battery 913 includes a terminal 951 and a terminal 952.

The circuit board 900 includes a circuit 912. The terminals 911 are connected to the terminal 951, the terminal 952, an antenna 914, an antenna 915, and the circuit 912 via the circuit board 900. Note that a plurality of terminals 911 serving as a control signal input terminal, a power supply terminal, and the like may be provided.

The circuit 912 may be provided on the rear surface of the circuit board 900. Note that the shape of the antenna 914 is not limited to a coil shape and may be a linear shape or a plate shape. Furthermore, a planar antenna, an aperture antenna, a traveling-wave antenna, an EH antenna, a magnetic-field antenna, a dielectric antenna, or the like may be used.

Alternatively, the antenna 914 may be a flat-plate conductor. The flat-plate conductor can serve as one of conductors for electric field coupling. That is, the antenna 914 can serve as one of two conductors of a capacitor. Thus, electric power can be transmitted and received not only by an electromagnetic field or a magnetic field but also by an electric field.

The battery pack includes a layer 916 between the secondary battery 913 and the antenna 914. The layer 916 has a function of preventing an influence on an electromagnetic field by the secondary battery 913, for example. As the layer 916, for example, a magnetic body can be used.

Note that the structure of the secondary battery is not limited to that illustrated in FIG. 16A and FIG. 16B.

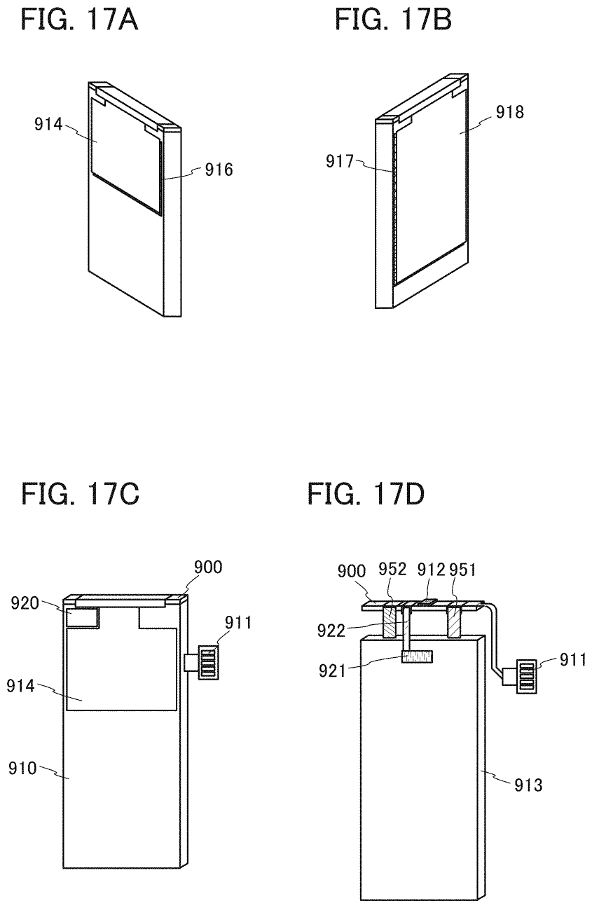

For example, as illustrated in FIG. 17A and FIG. 17B, two opposite surfaces of the battery pack illustrated in FIG. 16A and FIG. 16B may be provided with respective antennas. FIG. 17A is an external view seen from one side of the opposite surfaces, and FIG. 17B is an external view seen from the other side of the opposite surfaces. For the same portions as those in FIG. 16A and FIG. 16B, refer to the description of the battery pack illustrated in FIG. 16A and FIG. 16B as appropriate.

As illustrated in FIG. 17A, the antenna 914 is provided on one of the opposite surfaces of the secondary battery 913 with the layer 916 located therebetween, and as illustrated in FIG. 17B, an antenna 918 is provided on the other of the opposite surfaces of the secondary battery 913 with a layer 917 located therebetween. The layer 917 has a function of preventing an influence on an electromagnetic field by the secondary battery 913, for example. As the layer 917, for example, a magnetic body can be used.

With the above structure, both of the antenna 914 and the antenna 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as near field communication (NFC), can be employed.

Alternatively, as illustrated in FIG. 17C, the battery pack illustrated in FIG. 16A and FIG. 16B may be provided with a display device 920. The display device 920 is electrically connected to the terminal 911. Note that the label 910 is not necessarily provided in a portion where the display device 920 is provided. For portions similar to those in FIG. 16A and FIG. 16B, refer to the description of the battery pack illustrated in FIG. 16A and FIG. 16B as appropriate.

The display device 920 can display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 17D, the battery pack illustrated in FIG. 16A and FIG. 16B may be provided with a sensor 921. The sensor 921 is electrically connected to the terminal 911 via a terminal 922. For portions similar to those in FIG. 16A and FIG. 16B, refer to the description of the battery pack illustrated in FIG. 16A and FIG. 16B as appropriate.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment (e.g., temperature) where the secondary battery is placed can be acquired and stored in a memory inside the circuit 912.

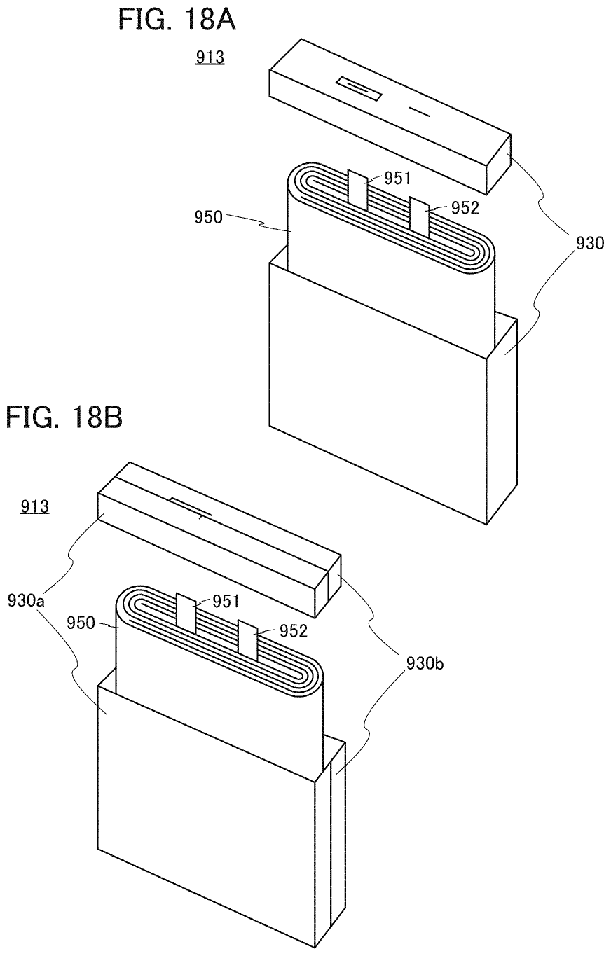

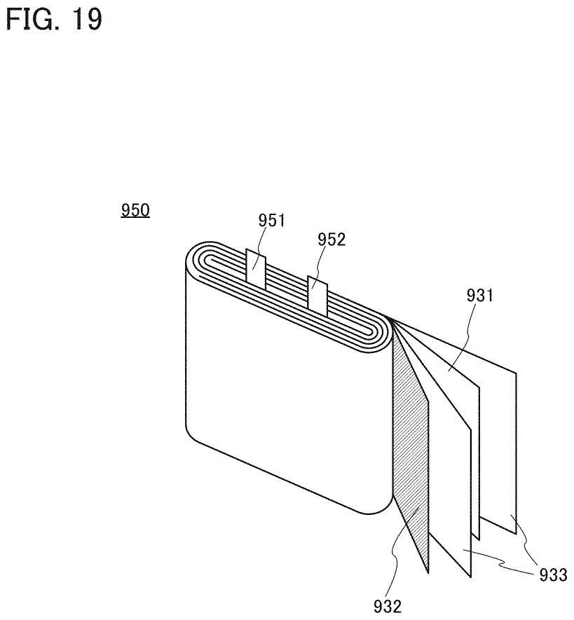

Furthermore, structure examples of the secondary battery 913 are described with reference to FIG. 18 and FIG. 19.

The secondary battery 913 illustrated in FIG. 18A includes a wound body 950 provided with the terminal 951 and the terminal 952 inside a housing 930. The wound body 950 is soaked in an electrolyte solution inside the housing 930. The terminal 952 is in contact with the housing 930. An insulator or the like inhibits contact between the terminal 951 and the housing 930. Note that in FIG. 18A, the housing 930 divided into two pieces is illustrated for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 18B, the housing 930 in FIG. 18A may be formed using a plurality of materials. For example, in the secondary battery 913 in FIG. 18B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna such as the antenna 914 and the antenna 915 may be provided inside the housing 930a. For the housing 930b, a metal material can be used, for example.

FIG. 19 illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks each including the negative electrode 931, the positive electrode 932, and the separator 933 may be stacked.

The negative electrode 931 is connected to the terminal 911 in FIG. 16A, FIG. 16B, and the like via one of the terminal 951 and the terminal 952. The positive electrode 932 is connected to the terminal 911 in FIG. 16A, FIG. 16B, and the like via the other of the terminal 951 and the terminal 952.

When the positive electrode active material described in the above embodiment is used in the positive electrode 932, the secondary battery 913 with high capacity and excellent cycle performance can be obtained.

### [Laminated Secondary Battery]

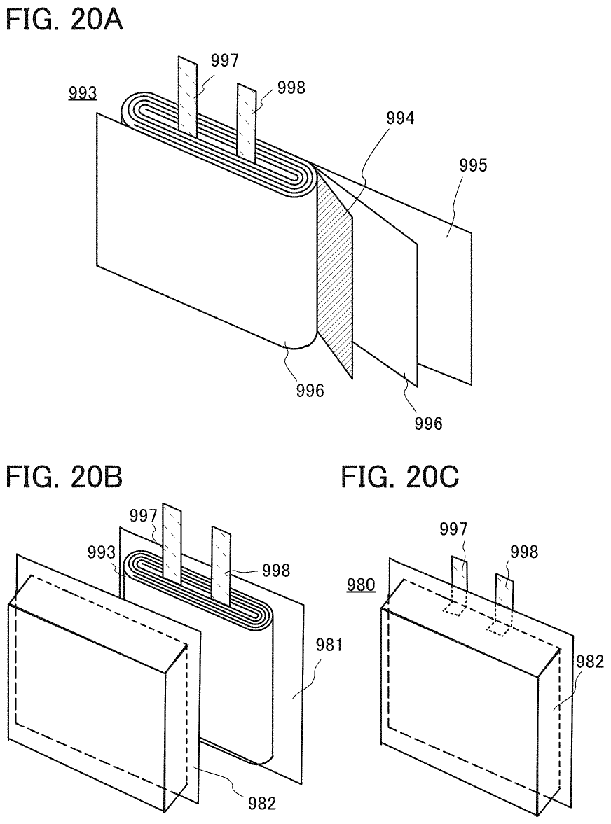

Next, an example of a laminated secondary battery is described with reference to FIG. 20 to FIG. 26. When the laminated secondary battery has flexibility and is used in an electronic device at least part of which is flexible, the secondary battery can be bent as the electronic device is bent.

A laminated secondary battery 980 is described with reference to FIG. 20A, FIG. 20B, and FIG. 20C. The laminated secondary battery 980 includes a wound body 993 illustrated in FIG. 20A. The wound body 993 includes a negative electrode 994, a positive electrode 995, and separators 996. The wound body 993 is, like the wound body 950 illustrated in FIG. 19, obtained by winding a sheet of a stack in which the negative electrode 994 overlaps with the positive electrode 995 with the separator 996 provided therebetween.

Note that the number of stacks each including the negative electrode 994, the positive electrode 995, and the separator 996 may be determined as appropriate depending on required capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 20B, the wound body 993 is packed in a space formed by bonding a film 981 and a film 982 having a depressed portion that serve as exterior bodies by thermocompression bonding or the like, whereby the secondary battery 980 illustrated in FIG. 20C can be formed. The wound body 993 includes the lead electrode 997 and the lead electrode 998, and is soaked in an electrolyte solution inside a space surrounded by the film 981 and the film 982 having a depressed portion.

For the film 981 and the film 982 having a depressed portion, a metal material such as aluminum or a resin material can be used, for example. With the use of a resin material for the film 981 and the film 982 having a depressed portion, the film 981 and the film 982 having a depressed portion can be changed in their forms when external force is applied; thus, a flexible storage battery can be formed.

Although FIG. 20B and FIG. 20C illustrate an example where a space is formed by two films, the wound body 993 may be placed in a space formed by bending one film.

When the positive electrode active material described in the above embodiment is used in the positive electrode 995, the secondary battery 980 with high capacity and excellent cycle performance can be obtained.

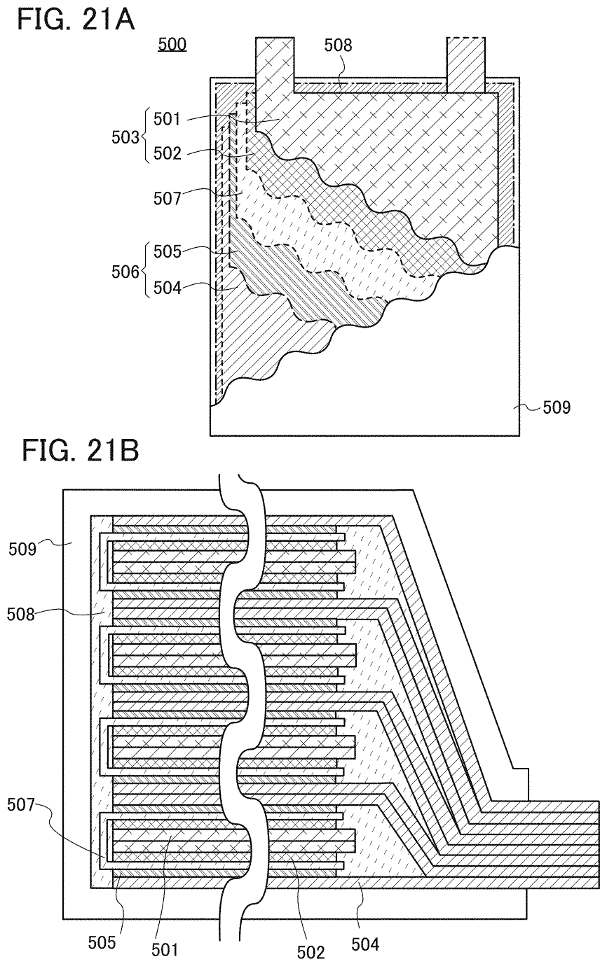

In FIG. 20B and FIG. 20C, an example in which the secondary battery 980 includes a wound body in a space formed by films serving as exterior bodies is described; however, as illustrated in FIG. 21A, a secondary battery may include a plurality of strip-shaped positive electrodes, a plurality of strip-shaped separators, and a plurality of strip-shaped negative electrodes in a space formed by films serving as exterior bodies, for example.

A laminated secondary battery 500 illustrated in FIG. 21A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508. The electrolyte solution described in Embodiment 2 can be used as the electrolyte solution 508.

In the laminated secondary battery 500 illustrated in FIG. 21A, the positive electrode current collector 501 and the negative electrode current collector 504 also serve as terminals for electrical contact with the outside. For this reason, the positive electrode current collector 501 and the negative electrode current collector 504 may be arranged so that part of the positive electrode current collector 501 and part of the negative electrode current collector 504 are exposed to the outside of the exterior body 509. Alternatively, a lead electrode and the positive electrode current collector 501 or the negative electrode current collector 504 may be bonded to each other by ultrasonic welding, and instead of the positive electrode current collector 501 and the negative electrode current collector 504, the lead electrode may be exposed to the outside of the exterior body 509.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

FIG. 21B illustrates an example of a cross-sectional structure of the laminated secondary battery 500. Although FIG. 21A illustrates an example in which only two current collectors are included for simplicity, an actual battery includes a plurality of electrode layers as illustrated in FIG. 21B.

In FIG. 21B, the number of electrode layers is 16, for example. The laminated secondary battery 500 has flexibility even though including 16 electrode layers. FIG. 21B illustrates a structure including 8 layers of negative electrode current collectors 504 and 8 layers of positive electrode current collectors 501, i.e., 16 layers in total. Note that FIG. 21B illustrates a cross section of the lead portion of the negative electrode, and the 8 layers of the negative electrode current collectors 504 are bonded to each other by ultrasonic welding. It is needless to say that the number of electrode layers is not limited to 16, and may be more than 16 or less than 16. With a large number of electrode layers, the secondary battery can have high capacity. By contrast, with a small number of electrode layers, the secondary battery can have small thickness and high flexibility.

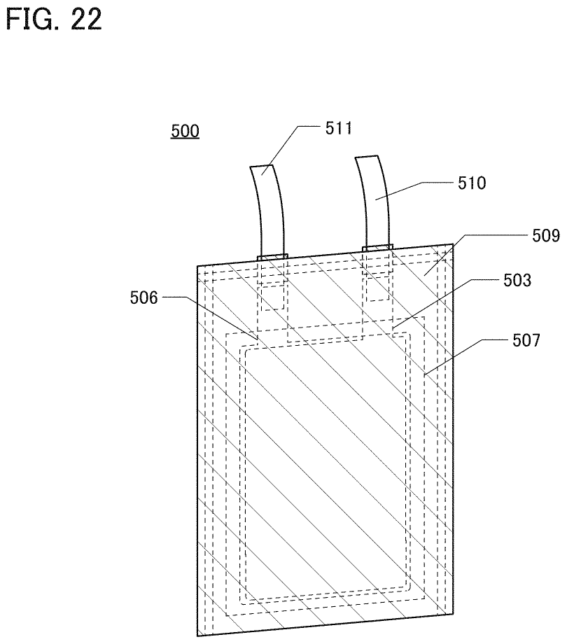

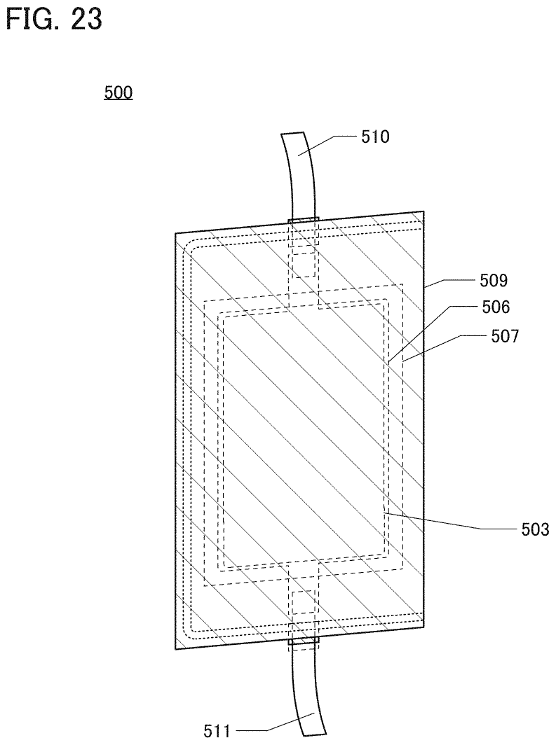

FIG. 22 and FIG. 23 each illustrate an example of the external view of the laminated secondary battery 500. In FIG. 22 and FIG. 23, the laminated secondary battery 500 includes the positive electrode 503, the negative electrode 506, the separator 507, the exterior body 509, a positive electrode lead electrode 510, and a negative electrode lead electrode 511.

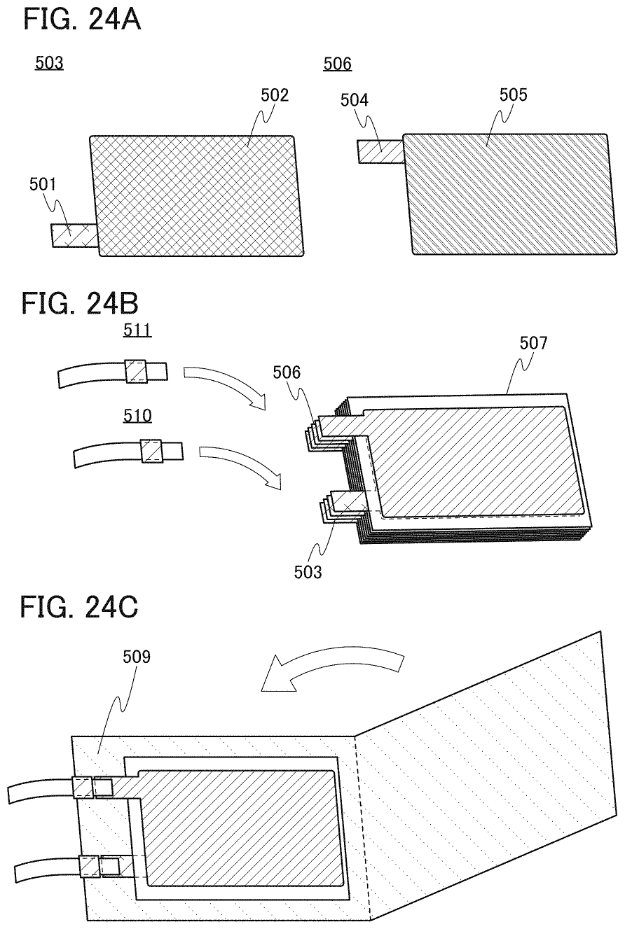

FIG. 24A illustrates external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 24A.

### [Method for Forming Laminated Secondary Battery]

Here, an example of a method for forming the laminated secondary battery whose external view is illustrated in FIG. 22 is described with reference to FIG. 24B and FIG. 24C.

First, the negative electrode 506, the separator 507, and the positive electrode 503 are stacked. FIG. 24B illustrates a stack including the negative electrode 506, the separator 507, and the positive electrode 503. The secondary battery described here as an example includes 5 negative electrodes and 4 positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a dashed line as illustrated in FIG. 24C. Then, the outer edges of the exterior body 509 are bonded to each other. The bonding can be performed by thermocompression, for example. At this time, a part (or one side) of the exterior body 509 is left unbonded (to provide an inlet) so that the electrolyte solution 508 can be introduced later.

Next, the electrolyte solution 508 (not illustrated) is introduced into the exterior body 509 from the inlet of the exterior body 509. The electrolyte solution 508 is preferably introduced in a reduced pressure atmosphere or in an inert gas atmosphere. Lastly, the inlet is sealed by bonding. In the above manner, the laminated secondary battery 500 can be manufactured.

When the positive electrode active material described in the above embodiment is used in the positive electrode 503, the secondary battery 500 with high capacity and excellent cycle performance can be obtained.

### [Bendable Secondary Battery]

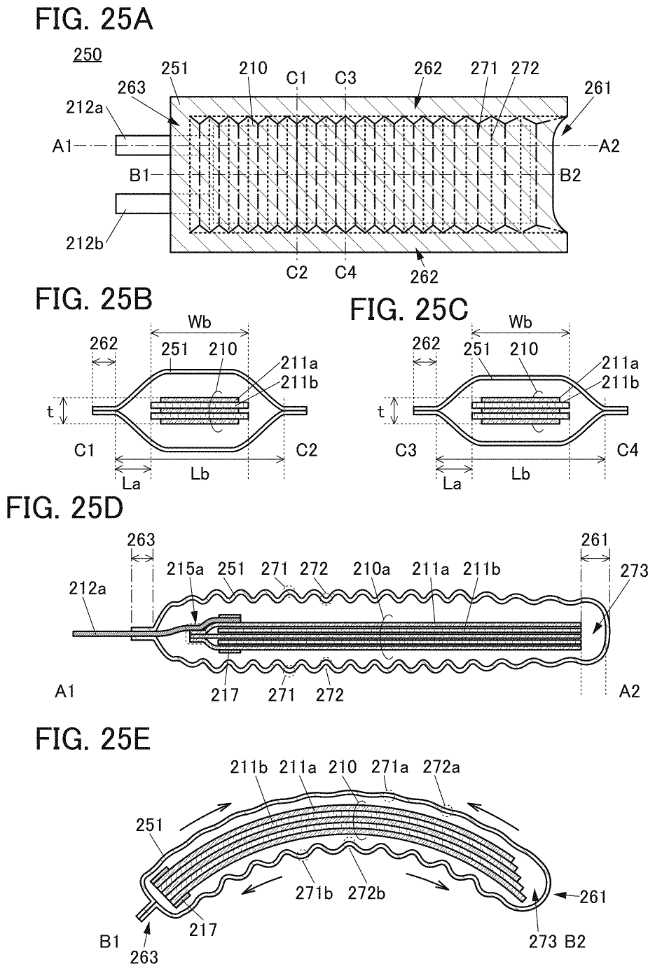

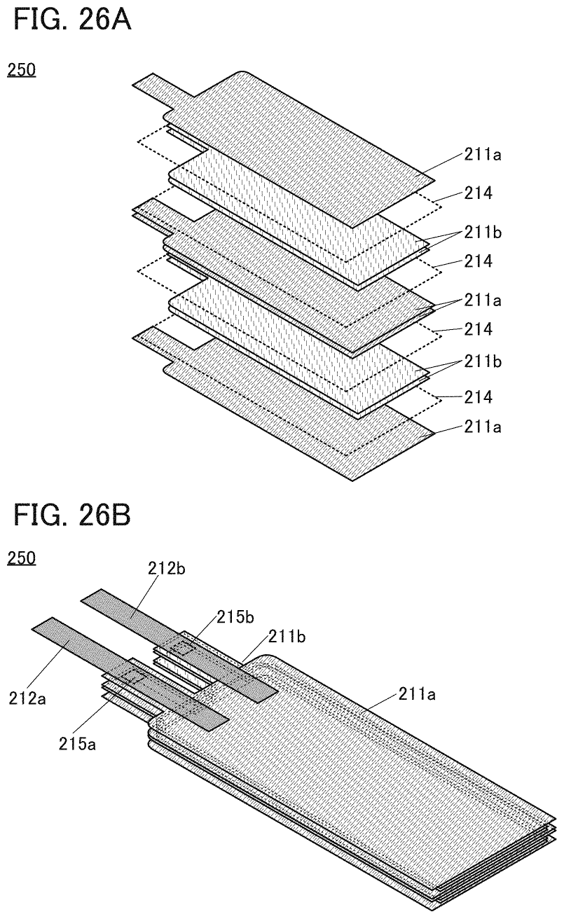

Next, an example of a bendable secondary battery is described with reference to FIG. 25A to FIG. 25E, FIG. 26A, and FIG. 26B.

FIG. 25A is a schematic top view of a bendable secondary battery 250. FIG. 25B, FIG. 25C, and FIG. 25D are schematic cross-sectional views taken along the cutting line C1-C2, the cutting line C3-C4, and the cutting line A1-A2, respectively, in FIG. 25A. The secondary battery 250 includes an exterior body 251 and a positive electrode 211a and a negative electrode 211b held in the exterior body 251. A lead 212a electrically connected to the positive electrode 211a and a lead 212b electrically connected to the negative electrode 211b are extended to the outside of the exterior body 251. In addition to the positive electrode 211a and the negative electrode 211b, an electrolyte solution (not illustrated) is enclosed in a region surrounded by the exterior body 251.

FIG. 26A and FIG. 26B illustrate the positive electrode 211a and the negative electrode 211b included in the secondary battery 250. FIG. 26A is a perspective view illustrating the stacking order of the positive electrode 211a, the negative electrode 211b, and a separator 214. FIG. 26B is a perspective view illustrating the lead 212a and the lead 212b in addition to the positive electrode 211a and the negative electrode 211b.

As illustrated in FIG. 26A, the secondary battery 250 includes a plurality of strip-shaped positive electrodes 211a, a plurality of strip-shaped negative electrodes 211b, and a plurality of separators 214. The positive electrode 211a and the negative electrode 211b each include a projected tab portion and a portion other than the tab portion. A positive electrode active material layer is formed on one surface of the positive electrode 211a other than the tab portion, and a negative electrode active material layer is formed on one surface of the negative electrode 211b other than the tab portion.

The positive electrodes 211a and the negative electrodes 211b are stacked so that surfaces of the positive electrodes 211a on each of which the positive electrode active material layer is not formed are in contact with each other and that surfaces of the negative electrodes 211b on each of which the negative electrode active material is not formed are in contact with each other.

Furthermore, the separator 214 is provided between the surface of the positive electrode 211a on which the positive electrode active material is formed and the surface of the negative electrode 211b on which the negative electrode active material is formed. In FIG. 26A, the separator 214 is shown by a dotted line for easy viewing.

In addition, as illustrated in FIG. 26B, the plurality of positive electrodes 211a are electrically connected to the lead 212a in a bonding portion 215a. The plurality of negative electrodes 211b are electrically connected to the lead 212b in a bonding portion 215b.

Next, the exterior body 251 is described with reference to FIG. 25B, FIG. 25C, FIG. 25D, and FIG. 25E.

The exterior body 251 has a film-like shape and is folded in half with the positive electrodes 211a and the negative electrodes 211b between facing portions of the exterior body 251. The exterior body 251 includes a folded portion 261, a pair of seal portions 262, and a seal portion 263. The pair of seal portions 262 is provided with the positive electrodes 211a and the negative electrodes 211b positioned therebetween and thus can also be referred to as side seals. The seal portion 263 includes portions overlapping with the lead 212a and the lead 212b and can also be referred to as a top seal.

Part of the exterior body 251 that overlaps with the positive electrodes 211a and the negative electrodes 211b preferably has a wave shape in which crest lines 271 and trough lines 272 are alternately arranged. The seal portions 262 and the seal portion 263 of the exterior body 251 are preferably flat.

FIG. 25B shows a cross section along the part overlapping with the crest line 271. FIG. 25C shows a cross section along the part overlapping with the trough line 272. FIG. 25B and FIG. 25C correspond to cross sections of the secondary battery 250, the positive electrodes 211a, and the negative electrodes 211b in the width direction.

Here, the distance between end portions of the positive electrode 211a and the negative electrode 211b in the width direction and the seal portion 262, that is, the distance between the end portions of the positive electrode 211a and the negative electrode 211b and the seal portion 262 is referred to as a distance La. When the secondary battery 250 changes in shape, for example, is bent, the positive electrode 211a and the negative electrode 211b change in shape such that the positions thereof are shifted from each other in the length direction as described later. At the time, if the distance La is too short, the exterior body 251 and the positive electrode 211a and the negative electrode 211b are rubbed hard against each other, so that the exterior body 251 is damaged in some cases. In particular, when a metal film of the exterior body 251 is exposed, the metal film might be corroded by the electrolyte solution. Therefore, the distance La is preferably set as long as possible. However, if the distance La is too long, the volume of the secondary battery 250 is increased.

The distance La between the positive and negative electrodes 211a and 211b and the seal portion 262 is preferably increased as the total thickness of the stacked positive electrodes 211a and negative electrodes 211b is increased.

Specifically, when the total thickness of the stacked positive electrodes 211a, negative electrodes 211b, and separators 214 (not illustrated) is referred to as a thickness t, the distance La is preferably 0.8 times or more and 3.0 times or less, further preferably 0.9 times or more and 2.5 times or less, still further preferably 1.0 times or more and 2.0 times or less as large as the thickness t. When the distance La is in the above range, a compact battery highly reliable for bending can be obtained.

Furthermore, when the distance between the pair of seal portions 262 is referred to as a distance Lb, it is preferred that the distance Lb be sufficiently longer than the widths of the positive electrode 211a and the negative electrode 211b (here, a width Wb of the negative electrode 211b). In that case, even when the positive electrode 211a and the negative electrode 211b come into contact with the exterior body 251 by change in the shape of the secondary battery 250, such as repeated bending, the position of part of the positive electrode 211a and the negative electrode 211b can be shifted in the width direction; thus, the positive and negative electrodes 211a and 211b and the exterior body 251 can be effectively prevented from being rubbed against each other.

For example, the difference between the distance Lb (i.e., the distance between the pair of seal portions 262) and the width Wb of the negative electrode 211b is preferably greater than or equal to 1.6 times and less than or equal to 6.0 times, further preferably greater than or equal to 1.8 times and less than or equal to 5.0 times, still further preferably greater than or equal to 2.0 times and less than or equal to 4.0 times the total thickness t of the positive electrode 211a and the negative electrode 211b which are stacked and a separator 214 (not illustrated).

In other words, the distance Lb, the width Wb, and the thickness t preferably satisfy the relationship of Formula 1 below.

$$\begin{matrix}[ Formula 1 ] & \\ \frac{L b - W b}{2 t} \geq a & ( Formula 1 )\end{matrix}$$

In the formula, a is 0.8 or more and 3.0 or less, preferably 0.9 or more and 2.5 or less, further preferably 1.0 or more and 2.0 or less.

FIG. 25D illustrates a cross section including the lead 212a and corresponds to a cross section of the secondary battery 250, the positive electrode 211a, and the negative electrode 211b in the length direction. As illustrated in FIG. 25D, a space 273 is preferably provided between the end portions of the positive electrode 211a and the negative electrode 211b in the length direction and the exterior body 251 in the folded portion 261.

FIG. 25E is a schematic cross-sectional view of the secondary battery 250 in a state of being bent. FIG. 25E corresponds to a cross section along the cutting line B1-B2 in FIG. 25A.

When the secondary battery 250 is bent, a part of the exterior body 251 positioned on the outer side in bending is unbent and the other part positioned on the inner side changes its shape as it shrinks. More specifically, the part of the exterior body 251 positioned on the outer side in bending changes its shape such that the wave amplitude becomes smaller and the length of the wave period becomes larger. By contrast, the part of the exterior body 251 positioned on the inner side changes its shape such that the wave amplitude becomes larger and the length of the wave period becomes smaller. When the exterior body 251 changes its shape in this manner, stress applied to the exterior body 251 due to bending is relieved, so that a material itself of the exterior body 251 does not need to expand and contract. Thus, the secondary battery 250 can be bent with weak force without damage to the exterior body 251.

Furthermore, as illustrated in FIG. 25E, when the secondary battery 250 is bent, the positions of the positive electrode 211a and the negative electrode 211b are shifted relatively. At this time, ends of the stacked positive electrodes 211a and negative electrodes 211b on the seal portion 263 side are fixed by a fixing member 217. Thus, the plurality of positive electrodes 211a and the plurality of negative electrodes 211b are more shifted at a position closer to the folded portion 261. Therefore, stress applied to the positive electrode 211a and the negative electrode 211b is relieved, and the positive electrode 211a and the negative electrode 211b themselves do not need to expand and contract. Consequently, the secondary battery 250 can be bent without damage to the positive electrode 211a and the negative electrode 211b.

Furthermore, the space 273 is provided between the positive electrode 211a and the negative electrode 211b, whereby the relative positions of the positive electrode 211a and the negative electrode 211b can be shifted while the positive electrode 211a and the negative electrode 211b located on an inner side when the secondary battery 250 is bent do not come in contact with the exterior body 251.

In the secondary battery 250 illustrated in FIG. 25A to FIG. 25E, FIG. 26A, and FIG. 26B, the exterior body, the positive electrode 211a, and the negative electrode 211b are less likely to be damaged and the battery characteristics are less likely to deteriorate even when the secondary battery 250 is repeatedly bent and unbent. When the positive electrode active material described in the above embodiment are used in the positive electrode 211a included in the secondary battery 250, a battery with better cycle performance can be obtained.

### Embodiment 4

In this embodiment, examples of electronic devices each including the secondary battery of one embodiment of the present invention are described.

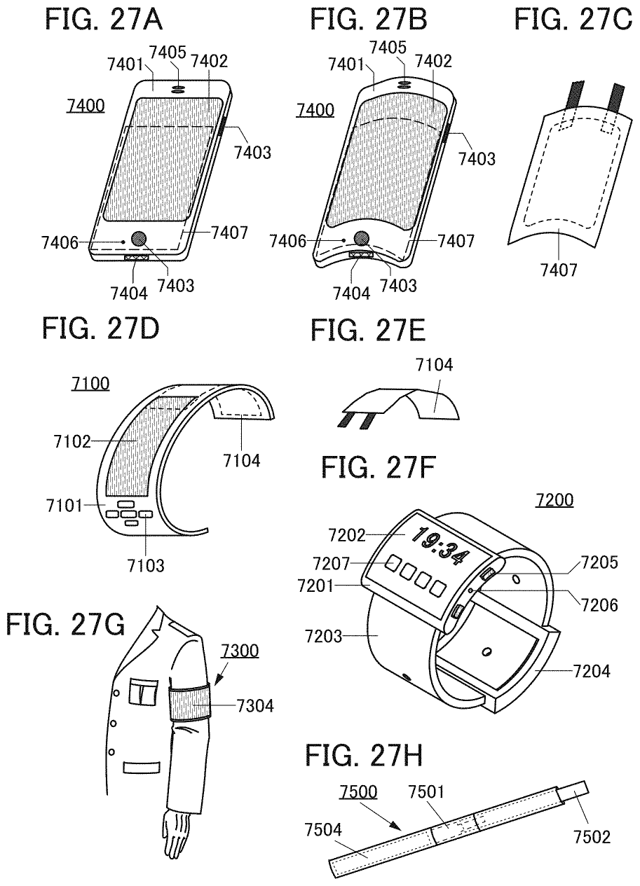

First, FIGS. 27A to 27G show examples of electronic devices including the bendable secondary battery described in Embodiment 3. Examples of electronic devices each including a bendable secondary battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

In addition, a flexible secondary battery can be incorporated along a curved inside/outside wall surface of a house or a building or a curved interior/exterior surface of an automobile.

FIG. 27A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 27B illustrates the mobile phone 7400 that is bent. When the whole mobile phone 7400 is bent by the external force, the secondary battery 7407 included in the mobile phone 7400 is also bent. FIG. 27C illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 27D illustrates an example of a bangle display device. A portable display device 7100 includes a housing 7101, a display portion 7102, operation buttons 7103, and a secondary battery 7104. FIG. 27E illustrates the bent secondary battery 7104. When the display device is worn on a user's arm while the secondary battery 7104 is bent, the housing changes its shape and the curvature of part or the whole of the secondary battery 7104 is changed. Note that the radius of curvature of a curve at a point refers to the radius of the circular arc that best approximates the curve at that point. The reciprocal of the radius of curvature is curvature. Specifically, part or the whole of the housing or the main surface of the secondary battery 7104 is changed in the range of radius of curvature from 40 mm to 150 mm inclusive. When the radius of curvature at the main surface of the secondary battery 7104 is greater than or equal to 40 mm and less than or equal to 150 mm, the reliability can be kept high. When the secondary battery of one embodiment of the present invention is used as the secondary battery 7104, a lightweight portable display device with a long lifetime can be provided.

FIG. 27F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operation system incorporated in the portable information terminal 7200.

The portable information terminal 7200 can employ near field communication that is a communication method based on an existing communication standard. In that case, for example, mutual communication between the portable information terminal 7200 and a headset capable of wireless communication can be performed, and thus hands-free calling is possible.

Moreover, the portable information terminal 7200 includes the input/output terminal 7206, and data can be directly transmitted to and received from another information terminal via a connector. In addition, charge via the input/output terminal 7206 is possible. Note that the charge operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 27E that is in the state of being curved can be provided in the housing 7201. Alternatively, the secondary battery 7104 illustrated in FIG. 27E can be provided in the band 7203 such that it can be curved.

The portable information terminal 7200 preferably includes a sensor. As the sensor, for example a human body sensor such as a fingerprint sensor, a pulse sensor, or a temperature sensor, a touch sensor, a pressure sensitive sensor, or an acceleration sensor is preferably mounted.

FIG. 27G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication, which is a communication method based on an existing communication standard.

The display device 7300 includes an input/output terminal, and data can be directly transmitted to and received from another information terminal via a connector. In addition, charge via the input/output terminal is possible. Note that the charge operation may be performed by wireless power feeding without using the input/output terminal.

When the secondary battery of one embodiment of the present invention is used as the secondary battery included in the display device 7300, a lightweight display device with a long lifetime can be provided.

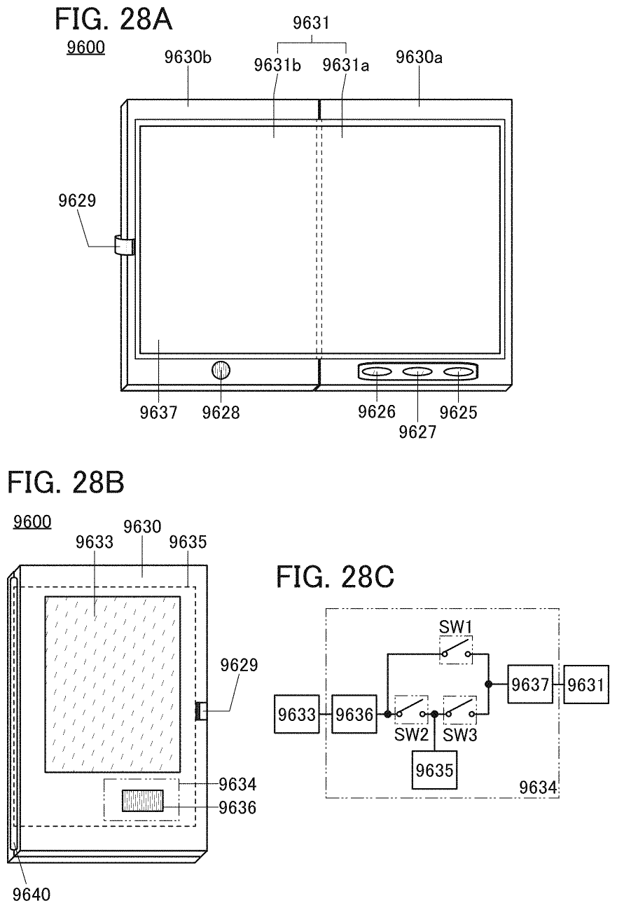

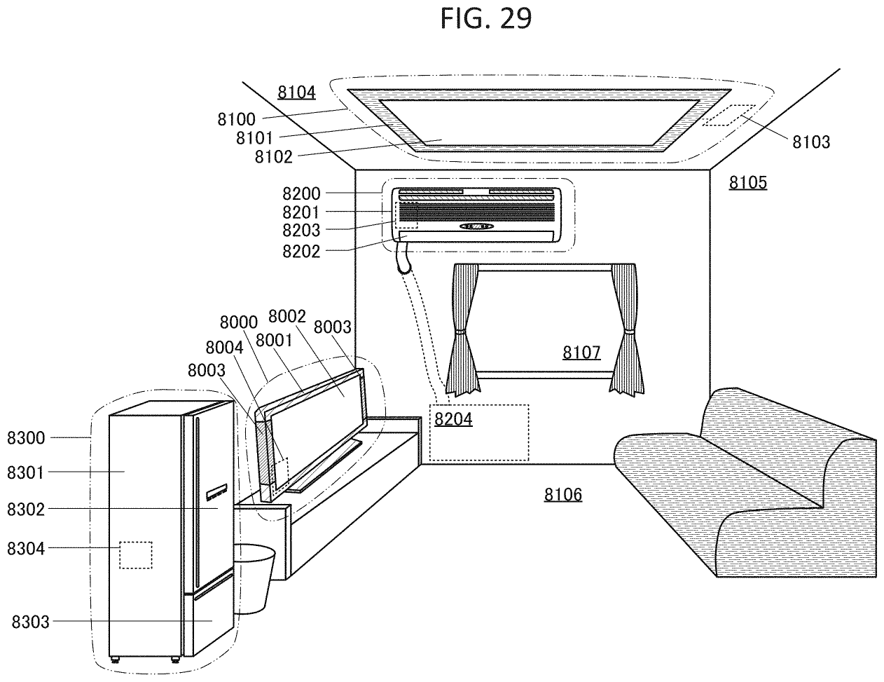

In addition, examples of electronic devices each including the secondary battery with excellent cycle performance described in the above embodiment are described with reference to FIG. 27H, FIG. 28A, FIG. 28B, and FIG. 29.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high capacity are desired in consideration of handling ease for users.

FIG. 27H is a perspective view of a device called a vaporizer (electronic cigarette). In FIG. 27H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and overdischarge of the secondary battery 7504 may be electrically connected to the secondary battery 7504. The secondary battery 7504 in FIG. 27H includes an external terminal for connection to a charger. When the electronic cigarette 7500 is held by a user, the secondary battery 7504 becomes a tip portion; thus, it is preferred that the secondary battery 7504 have a short total length and be lightweight. With the secondary battery of one embodiment of the present invention, which has high capacity and excellent cycle performance, the small and lightweight electronic cigarette 7500 that can be used for a long time over a long period can be provided.

Next, FIGS. 28A and 28B illustrate an example of a tablet terminal that can be folded in half. A tablet terminal 9600 illustrated in FIGS. 28A and 28B includes a housing 9630a, a housing 9630b, a movable portion 9640 connecting the housings 9630a and 9630b to each other, a display portion 9631 including a display portion 9631a and a display portion 9631b, a switch 9625 to a switch 9627, a fastener 9629, and an operation switch 9628. A flexible panel is used for the display portion 9631, whereby a tablet terminal with a larger display portion can be provided. FIG. 28A illustrates the tablet terminal 9600 that is opened, and FIG. 28B illustrates the tablet terminal 9600 that is closed.

The tablet terminal 9600 includes a power storage unit 9635 inside the housing 9630a and the housing 9630b. The power storage unit 9635 is provided across the housings 9630a and 9630b, passing through the movable portion 9640.

Part of or the entire display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text or an image is displayed on the display portion 9631b on the housing 9630b side.

In addition, it is possible that a keyboard is displayed on the display portion 9631b on the housing 9630b side, and data such as text or an image is displayed on the display portion 9631a on the housing 9630a side. Furthermore, it is possible that a switching button for showing/hiding a keyboard on a touch panel is displayed on the display portion 9631 and the button is touched with a finger, a stylus, or the like to display keyboard buttons on the display portion 9631.

In addition, touch input can be performed concurrently in a touch panel region in the display portion 9631a on the housing 9630a side and a touch panel region in the display portion 9631b on the housing 9630b side.

The switches 9625 to 9627 may function not only as an interface for operating the tablet terminal 9600 but also as an interface that can switch various functions. For example, at least one of the switches 9625 to 9627 may have a function of switching on/off of the tablet terminal 9600. For another example, at least one of the switches 9625 to 9627 may have a function of switching display between a portrait mode and a landscape mode and a function of switching display between monochrome display and color display. For another example, at least one of the switches 9625 to 9627 may have a function of adjusting the luminance of the display portion 9631. The display luminance of the display portion 9631 can be controlled in accordance with the amount of external light in use of the tablet terminal 9600 detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

The display portion 9631a on the housing 9630a side and the display portion 9631b on the housing 9630b side have substantially the same display area in FIG. 28A; however, there is no particular limitation on the display areas of the display portions 9631a and 9631b, and the display portions may have different areas or different display quality. For example, one of the display portions 9631a and 9631b may display higher definition images than the other.

The tablet terminal 9600 is folded in half in FIG. 28B. The tablet terminal 9600 includes a housing 9630, a solar cell 9633, and a charge and discharge control circuit 9634 including a DCDC converter 9636. The power storage unit of one embodiment of the present invention is used as the power storage unit 9635.

The tablet terminal 9600 can be folded in half such that the housings 9630a and 9630b overlap with each other when not in use. Thus, the display portion 9631 can be protected, which increases the durability of the tablet terminal 9600. With the power storage unit 9635 including the secondary battery of one embodiment of the present invention, which has high capacity and excellent cycle performance, the tablet terminal 9600 that can be used for a long time over a long period can be provided.

The tablet terminal 9600 illustrated in FIGS. 28A and 28B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal 9600, supplies electric power to a touch panel, a display portion, a video signal processing portion, and the like. Note that the solar cell 9633 can be provided on one or both surfaces of the housing 9630 and the power storage unit 9635 can be charged efficiently. The use of a lithium-ion battery as the power storage unit 9635 brings an advantage such as a reduction in size.

The structure and operation of the charge and discharge control circuit 9634 illustrated in FIG. 28B are described with reference to a block diagram in FIG. 28C. The solar cell 9633, the power storage unit 9635, the DCDC converter 9636, a converter 9637, switches SW1 to SW3, and the display portion 9631 are illustrated in FIG. 28C, and the power storage unit 9635, the DCDC converter 9636, the converter 9637, and the switches SW1 to SW3 correspond to the charge and discharge control circuit 9634 in FIG. 28B.

First, an operation example in which electric power is generated by the solar cell 9633 using external light is described. The voltage of electric power generated by the solar cell is raised or lowered by the DCDC converter 9636 to a voltage for charging the power storage unit 9635. When the display portion 9631 is operated with the electric power from the solar cell 9633, the switch SW1 is turned on and the voltage of the electric power is raised or lowered by the converter 9637 to a voltage needed for operating the display portion 9631. When display on the display portion 9631 is not performed, the switch SW1 is turned off and the switch SW2 is turned on, so that the power storage unit 9635 can be charged.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the power storage unit 9635 may be charged with a non-contact power transmission module that transmits and receives power wirelessly (without contact), or with a combination of other charge units.

FIG. 29 illustrates other examples of electronic devices. In FIG. 29, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can receive electric power from a commercial power supply. Alternatively, the display device 8000 can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides TV broadcast reception.

In FIG. 29, an installation lighting device 8100 is an example of an electronic device including a secondary battery 8103 of one embodiment of the present invention. Specifically, the lighting device 8100 includes a housing 8101, a light source 8102, the secondary battery 8103, and the like. Although FIG. 29 illustrates the case where the secondary battery 8103 is provided in a ceiling 8104 on which the housing 8101 and the light source 8102 are installed, the secondary battery 8103 may be provided in the housing 8101. The lighting device 8100 can receive electric power from a commercial power supply. Alternatively, the lighting device 8100 can use electric power stored in the secondary battery 8103. Thus, the lighting device 8100 can be operated with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 29 as an example, the secondary battery of one embodiment of the present invention can be used in an installation lighting device provided in, for example, a wall 8105, a floor 8106, or a window 8107 other than the ceiling 8104. Alternatively, the secondary battery of one embodiment of the present invention can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and an organic EL element are given as examples of the artificial light source.

In FIG. 29, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 29 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can receive electric power from a commercial power supply. Alternatively, the air conditioner can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 29 as an example, the secondary battery of one embodiment of the present invention can be used in an air conditioner in which the functions of an indoor unit and an outdoor unit are integrated in one housing.

In FIG. 29, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 29. The electric refrigerator-freezer 8300 can receive electric power from a commercial power supply. Alternatively, the electric refrigerator-freezer 8300 can use electric power stored in the secondary battery 8304. Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. The tripping of a breaker of a commercial power supply in use of an electronic device can be prevented by using the secondary battery of one embodiment of the present invention as an auxiliary power supply for supplying electric power which cannot be supplied enough by a commercial power supply.

In addition, in a time period when electronic devices are not used, particularly when the proportion of the amount of electric power which is actually used to the total amount of electric power which can be supplied from a commercial power supply source (such a proportion is referred to as a usage rate of electric power) is low, electric power can be stored in the secondary battery, whereby the usage rate of electric power can be reduced in a time period when the electronic devices are used. For example, in the case of the electric refrigerator-freezer 8300, electric power can be stored in the secondary battery 8304 in night time when the temperature is low and the refrigerator door 8302 and the freezer door 8303 are not often opened or closed. On the other hand, in daytime when the temperature is high and the refrigerator door 8302 and the freezer door 8303 are frequently opened and closed, the secondary battery 8304 is used as an auxiliary power supply; thus, the usage rate of electric power in daytime can be reduced.

According to one embodiment of the present invention, the secondary battery can have excellent cycle performance and improved reliability. Furthermore, according to one embodiment of the present invention, a secondary battery with high capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained. This embodiment can be implemented in appropriate combination with any of the other embodiments.

### Embodiment 5

In this embodiment, examples of vehicles each including the secondary battery of one embodiment of the present invention are described.

The use of secondary batteries in vehicles enables production of next-generation clean energy vehicles such as hybrid electric vehicles (HEVs), electric vehicles (EVs), and plug-in hybrid electric vehicles (PHEVs).

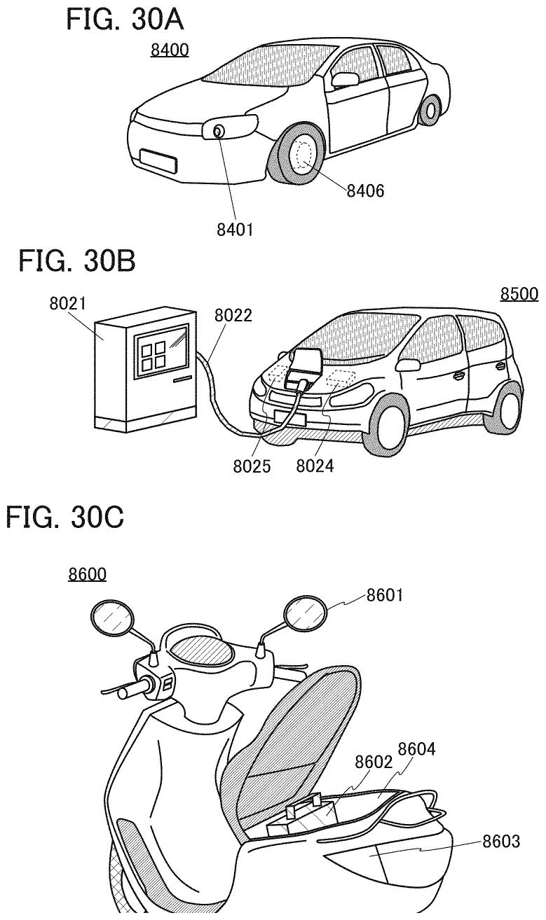

FIG. 30A, FIG. 30B, and FIG. 30C illustrate examples of a vehicle including the secondary battery of one embodiment of the present invention. An automobile 8400 illustrated in FIG. 30A is an electric vehicle that runs on the power of an electric motor. Alternatively, the automobile 8400 is a hybrid electric vehicle capable of driving using either an electric motor or an engine as appropriate. The use of one embodiment of the present invention allows fabrication of a high-mileage vehicle. The automobile 8400 includes the secondary battery. As the secondary battery, the modules of the secondary batteries illustrated in FIGS. 15C and 15D may be arranged to be used in a floor portion in the automobile. A battery pack in which a plurality of secondary batteries each of which is illustrated in FIG. 18A, FIG. 18B, and the like are combined may be placed in the floor portion in the automobile. The secondary battery is used not only for driving an electric motor 8406, but also for supplying electric power to a light-emitting device such as a headlight 8401 or a room light (not illustrated).

The secondary battery can also supply electric power to a display device included in the automobile 8400, such as a speedometer or a tachometer. Furthermore, the secondary battery can supply electric power to a semiconductor device included in the automobile 8400, such as a navigation system.

FIG. 30B illustrates an automobile 8500 including the secondary battery. The automobile 8500 can be charged when the secondary battery is supplied with electric power through external charge equipment by a plug-in system, a contactless power feeding system, or the like. In FIG. 30B, a secondary battery 8024 included in the automobile 8500 are charged with the use of a ground-based charge apparatus 8021 through a cable 8022. In charge, a given method such as CHAdeMO (registered trademark) or Combined Charging System may be employed as a charge method, the standard of a connector, or the like as appropriate. The charge apparatus 8021 may be a charge station provided in a commerce facility or a power source in a house. For example, with the use of a plug-in technique, the secondary battery 8024 included in the automobile 8500 can be charged by being supplied with electric power from outside. The charge can be performed by converting AC electric power into DC electric power through a converter such as an AC-DC converter 8025.

Furthermore, although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 30C shows an example of a motorcycle including the secondary battery of one embodiment of the present invention. A motor scooter 8600 illustrated in FIG. 30C includes a secondary battery 8602, side mirrors 8601, and indicators 8603. The secondary battery 8602 can supply electric power to the indicators 8603.

Furthermore, in the motor scooter 8600 illustrated in FIG. 30C, the secondary battery 8602 can be held in a storage unit under seat 8604. The secondary battery 8602 can be held in the storage unit under seat 8604 even with a small size. The secondary battery 8602 is detachable; thus, the secondary battery 8602 is carried indoors when charged, and is stored before the motor scooter is driven.

According to one embodiment of the present invention, the secondary battery can have improved cycle performance and the capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals such as cobalt can be reduced.

This embodiment can be implemented in appropriate combination with any of the other embodiments.

### Example 1

This example shows analysis results of the positive electrode active material of one embodiment of the present invention is described.

### <Formation of Positive Electrode Active Material>

The positive electrode active materials were formed with reference to the flowcharts illustrated in FIG. 8 and FIG. 9.

### [Sample 1 and Sample 2]

As Sample 1, NCM (specifications: Ni:Co:Mn=5:2:3) produced by MTI Corporation which is NCM (nickel cobalt lithium manganate) synthesized in advance was used. Furthermore, Sample 2 was obtained in such a manner that heat treatment at 700° C. for 2 hours was performed on Sample 1.

### [Sample 3 to Sample 7]

Next, Sample 3 to Sample 7 are described.

First, the mixture 902 including magnesium and fluorine was formed (Step S11 to Step S14 illustrated in FIG. 8, as a specific example of FIG. 6). First, LiF and MgF₂ were weighted so that the molar ratio of LiF to MgF₂ was LiF:MgF₂=1:3, acetone was added as a solvent, and the materials were mixed and ground by a wet process. The mixing and the grinding were performed in a ball mill using a zirconia ball at 150 rpm for one hour. The material that has been subjected to the treatment was collected to be the mixture 902.

Next, a composite oxide including lithium, nickel, manganese, and cobalt was prepared (Step S25). Here, NCM (specifications: Ni:Co:Mn=5:2:3) produced by MTI Corporation which is NCM synthesized in advance was used.

Then, the mixture 902 and NCM were mixed (Step S31). The materials were weighed so that the atomic weight of magnesium in the mixture 902 was approximately 0.5% of the atomic weight of the sum of the atomic weights of nickel, cobalt, and manganese included in NCM. The mixing was performed by a dry method. The mixing was performed in a ball mill using a zirconia ball at 150 rpm for one hour.

Subsequently, the materials that has been subjected to the treatment were collected to obtain the mixtures 903 (Step S32 and Step S33). The obtained mixture 903 was Sample 3.

Next, the mixture 903 was put in an alumina crucible and annealed using a muffle furnace in an oxygen atmosphere (Step S34). Sample 4 was annealed at 700° C. for 2 hours, Sample 5 was annealed at 700° C. for 60 hours, Sample 6 was annealed at 800° C. for 2 hours, and Sample 7 was annealed at 900° C. for 2 hours. At the time of annealing, the alumina crucible was covered with a lid. The flow rate of oxygen was 10 L/min. The temperature rise was 200° C./hr, and it took longer than or equal to 10 hours to lower the temperature.

The materials after the heat treatment were collected (Step S35) and sieved, so that Sample 4 to Sample 7 were obtained as the positive electrode active materials 100A_1 illustrated in FIG. 8 (Step S36). Table 1 describes whether each sample is mixed with the mixture 902 which corresponds to Step S31 to Step S33 (the “LiF and MgF₂” column of the table), and the conditions for the annealing which corresponds to Step S34 (“anneal (heat treatment)” column of the table).

TABLE 1

| | NCM | LiF and MgF₂ | anneal |
|---|---|---|---|
| Sample 1 | MTI-NCM-523 | Not included | Not done |
| Sample 2 | MTI-NCM-523 | Not included | 700° C., 2 hrs. |
| Sample 3 | MTI-NCM-523 | Included | Not done |
| Sample 4 | MTI-NCM-523 | Included | 700° C., 2 hrs. |
| Sample 5 | MTI-NCM-523 | Included | 700° C., 60 hrs. |
| Sample 6 | MTI-NCM-523 | Included | 800° C., 2 hrs. |
| Sample 7 | MTI-NCM-523 | Included | 900° C., 2 hrs. |

### <XPS>

The results of XPS analysis of the positive electrode active materials of Sample 1 to Sample 5 are shown in Table 2. The unit of the numerical values shown in Table 2 is atomic %.

TABLE 2

| | Li | Ni | Co | Mn | O | Mg | F | C | Ca | Na | S |
|---|---|---|---|---|---|---|---|---|---|---|---|
| Sample 1 | 12.0 | 8.6 | 2.6 | 5.9 | 44.2 | — | — | 26.5 | 0.3 | — | — |
| Sample 2 | 14.1 | 6.8 | 2.3 | 4.7 | 44.5 | — | — | 27.5 | 0.1 | — | — |
| Sample 3 | 12.7 | 7.8 | 2.6 | 5.8 | 42.0 | — | 1.6 | 27.4 | 0.2 | — | — |
| Sample 4 | 19.3 | 6.2 | 1.5 | 5.1 | 35.0 | — | 9.8 | 22.8 | — | — | 0.4 |
| Sample 5 | 19.4 | 6.0 | 1.8 | 5.4 | 35.0 | — | 7.8 | 24.0 | 0.1 | — | 0.4 |

In all the samples, the amount of magnesium was less than or equal to the detection lower limit. In Sample 4 and Sample 5, the proportions of nickel, cobalt, and oxygen tend to be lower and the proportions of lithium and fluorine tend to be higher than in Sample 1 to Sample 3. With a focus on the ratio of the elements to the sum of nickel, cobalt, and manganese, the proportion of manganese tends to be higher in Sample 4 and Sample 5 than in Sample 1 to Sample 3.

### <TEM>

Next, cross-sectional TEM observation of a particle of the positive electrode active material of Sample 4 was performed.

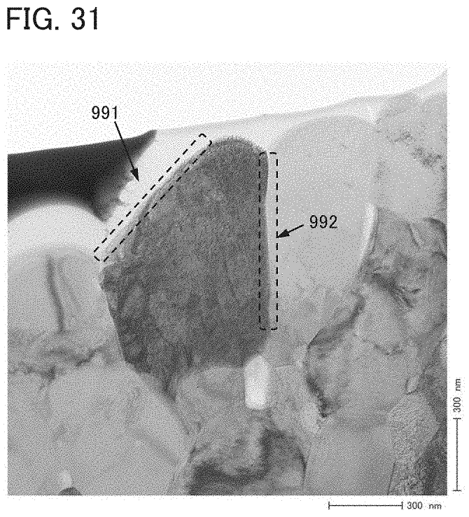

First, the sample was thinned by a focused ion beam (FIB) method before the observation. Then, the sample was observed. FIG. 31 shows an observation result of the cross-sectional TEM observation.

Next, EDX analysis was performed with a focus on a surface 991 and a grain boundary 992 shown in FIG. 31.

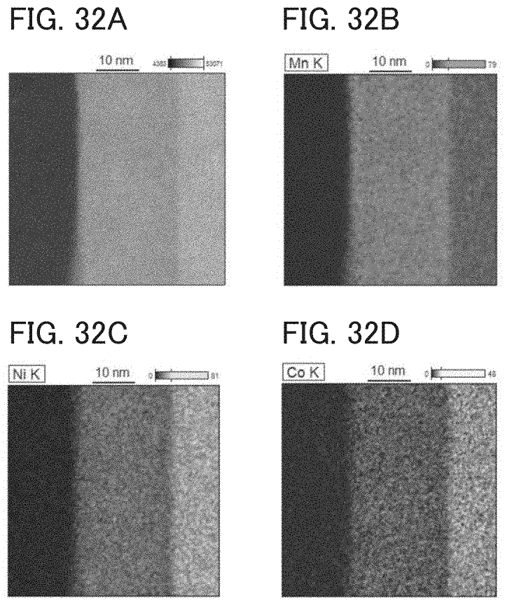

FIG. 32A is a HAADF-STEM image of the surface 991 and the vicinity thereof in a cross section of the particle. FIG. 32B, FIG. 32C, and FIG. 32D show results of EDX plane analysis of manganese, nickel and cobalt, respectively, corresponding to the portion shown in FIG. 32A.

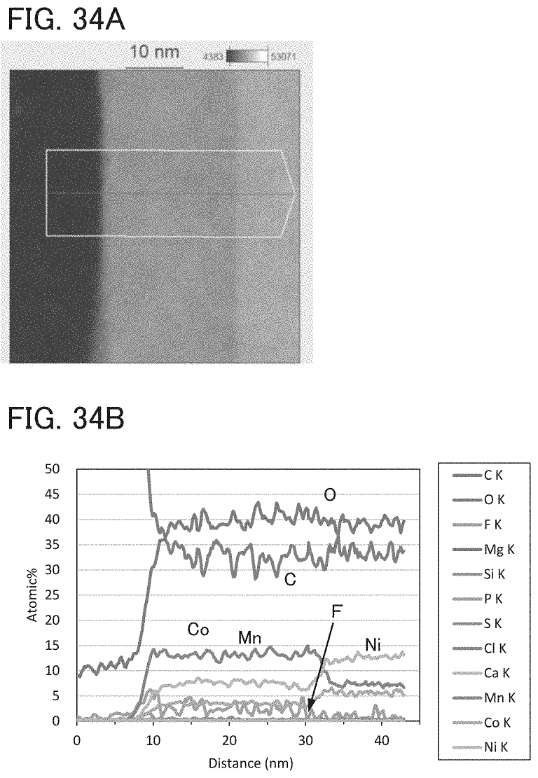

An EDX line analysis of the surface 991 and a region in the vicinity thereof was performed. FIG. 34A shows an HAADF-STEM image of the measured portion. FIG. 34B shows the concentrations of the elements corresponding to the portion shown in FIG. 34A.

The results in FIG. 32A to FIG. 32D, FIG. 34A, and FIG. 34B reveal that, in a region from the surface to a depth of approximately 20 nm, the concentration of manganese is higher and the concentrations of nickel and cobalt are lower than in the region to the greater depth. This indicates that, in a region from the surface of the particle to a depth of approximately 20 nm, a layer where the concentration of manganese is higher than that in the other region of the particle is formed.

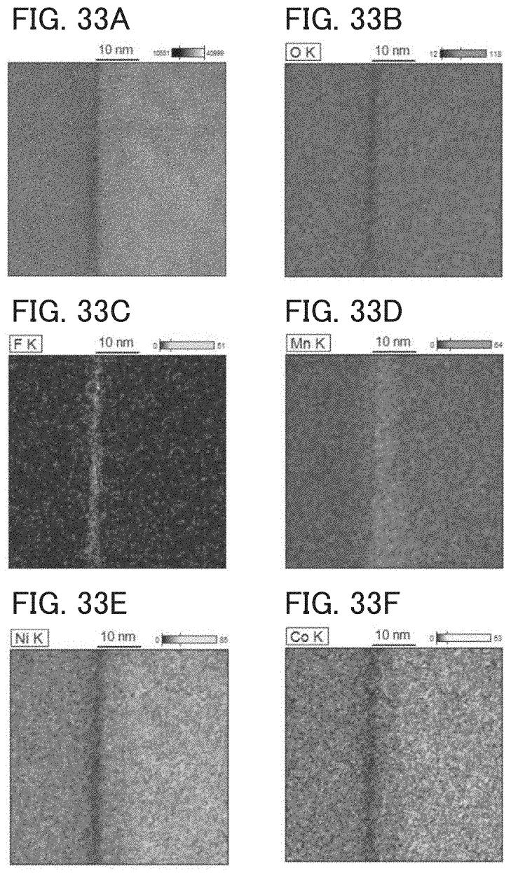

FIG. 33A is a HAADF-STEM image of the grain boundary 992 and the vicinity thereof in a cross section of the particle. FIG. 33B, FIG. 33C, FIG. 33D, FIG. 33E, and FIG. 33F show results of EDX plane analysis of oxygen, fluorine, manganese, nickel and cobalt, respectively, corresponding to the portion shown in FIG. 33A.

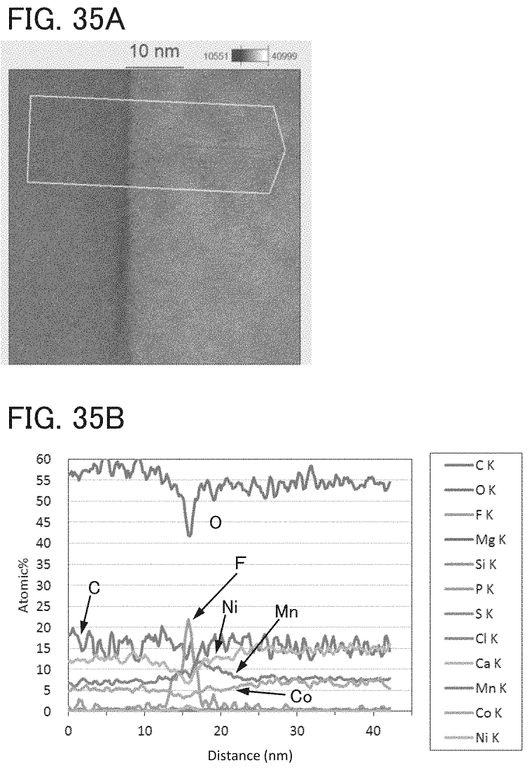

An EDX line analysis of the grain boundary and a region in the vicinity thereof was performed. FIG. 35A shows the measured portion. FIG. 35B shows the concentrations of the elements corresponding to the portion shown in FIG. 35A.

The results in FIG. 33A to FIG. 33F, FIG. 35A, and FIG. 35B reveal that, in the grain boundary and a region in the vicinity thereof, the concentrations of fluorine and manganese are higher and the concentrations of oxygen, nickel and cobalt are lower than in the region farther from the grain boundary.

### <EELS>

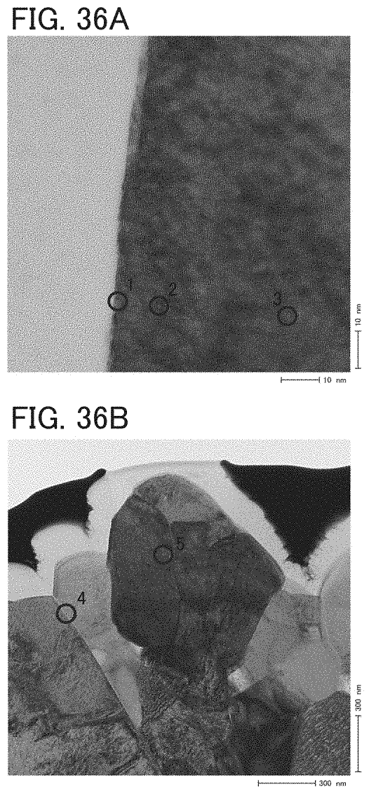

The EELS analyses of the five portions shown in FIG. 36A and FIG. 36B were performed. Five enclosed regions were marked with numbers 1, 2, 3, 4, and 5. Among the regions, the region marked with number 1 is a point 1, the region marked with number 2 is a point 2, the region marked with number 3 is a point 3, the region marked with number 4 is a point 4, and the region marked with number 5 is a point 5.

The EELS analyses of the three portions (the point 1, the point 2, and the point 3) of the cross section of the particle shown in FIG. 36A were performed. The point 1 is the vicinity of the particle surface, the point 2 is the region more inside than the point 1 by approximately 10 nm, and the point 3 is the region further more inside by approximately 30 nm.

The EELS analyses of the two portions (the point 4 and the point 5) of the cross section of the particle shown in FIG. 36B were performed. The point 4 is the grain boundary and the vicinity thereof and the point 5 is the region more inside than the grain boundary by approximately 50 nm.

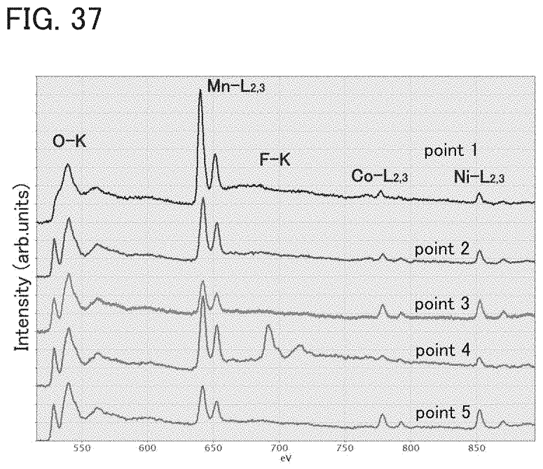

FIG. 37 shows EELS spectra of the point 1 to the point 5. Table 3 shows the L3/L2 peak ratios of the elements. The vertical axis in FIG. 37 represents intensity.

TABLE 3

| Measurement point | Ni-L3/L2 | Co-L3/L2 | Mn-L3/L2 |
|---|---|---|---|
| Point 1 | 3.2 | 3.2 | 3.2 |
| Point 2 | 3.3 | 2.1 | 2.2 |
| Point 3 | 3.4 | 2.9 | 2.0 |
| Point 4 | 3.0 | 1.4 | 2.1 |
| Point5 | 3.6 | 2.6 | 2.0 |

With a focus on nickel, it is indicated that the L3/L2 value tends to increase and the valence is lower than 3 and approximate to 2 in the region deeper than the particle surface. With a focus on manganese, it is indicated that the L3/L2 value tends to increase and the valence is lower than 4 and approximate to 2 in the region in the vicinity of the particle surface.

### Example 2

This example shows characteristics of a secondary battery using the positive electrode active material described in Example 1 and the like. As the positive electrode active material, Sample 1 to Sample 7 fabricated in Example 1 and Sample 8 and Sample 9 described below were used.

### <Formation of Positive Electrode Active Material>

The positive electrode active materials were formed with reference to the flowcharts illustrated in FIG. 8 and FIG. 9.

### [Sample 8]

As Sample 8, a material, which was NCM (nickel cobalt lithium manganate) synthesized in advance and produced by MTI Corporation and in which the ratio of nickel atoms to cobalt atoms and manganese atoms was Ni:Co:Mn=1:1:1 as specifications (hereinafter referred to as MTI-NCM-111), was used.

### [Sample 9]

Next, Sample 9 is described.

First, the mixture 902 including magnesium and fluorine was formed (Step S11 to Step S14 illustrated in FIG. 8, as a specific example of FIG. 6). First, LiF and MgF₂ were weighted so that the molar ratio of LiF to MgF₂ was LiF:MgF₂=1:3, acetone was added as a solvent, and the materials were mixed and ground by a wet process. The mixing and the grinding were performed in a ball mill using a zirconia ball at 150 rpm for one hour. The material that has been subjected to the treatment was collected to be the mixture 902.

Next, a composite oxide including lithium, nickel, manganese, and cobalt was prepared (Step S25). Here, MTI-NCM-111 described above was used.

Then, the mixture 902 and NCM were mixed (Step S31). The materials were weighed so that the atomic weight of magnesium in the mixture 902 was approximately 0.5% of the atomic weight of the sum of the atomic weights of nickel, cobalt, and manganese included in NCM. The mixing was performed by a dry method. The mixing was performed in a ball mill using a zirconia ball at 150 rpm for one hour.

Subsequently, the materials that has been subjected to the treatment were collected to obtain the mixtures 903 (Step S32 and Step S33).

Next, the mixture 903 was put in an alumina crucible and annealed at 700° C. using a muffle furnace in an oxygen atmosphere for 2 hours (Step S34). At the time of annealing, the alumina crucible was covered with a lid. The flow rate of oxygen was 10 L/min. The temperature rise was 200° C./hr, and it took longer than or equal to 10 hours to lower the temperature.

The materials after the heat treatment were collected (Step S35) and sieved, so that Sample 9 was obtained as the positive electrode active materials 100A_1 illustrated in FIG. 8 (Step S36). Table 4 describes whether each sample is mixed with the mixture 902 which corresponds to Step S31 to Step S33 (the “LiF and MgF₂” column of the table), and the conditions for the annealing which corresponds to Step S34 (“anneal (heat treatment)” column of the table).

TABLE 4

| | NCM | LiF and MgF₂ | anneal |
|---|---|---|---|
| Sample 8 | MTI-NCM-111 | Not included | Not done |
| Sample 9 | MTI-NCM-111 | Included | 700° C., 2 hrs. |

### <Fabrication of Secondary Battery>

Positive electrodes were fabricated using Sample 1 to Sample 9 obtained as the positive electrode active materials. A current collector that was coated with slurry in which the positive electrode active material, AB, and PVDF were mixed at the positive electrode active material:AB:PVDF=95:3:2 (weight ratio) was used. As a solvent of the slurry, NMP was used.

After the current collector was coated with the slurry, the solvent was volatilized. Then, the positive electrode was pressurized at 964 kN/m. Through the above process, the positive electrode was obtained. The carried amount of the positive electrode was approximately 7 mg/cm².

Using the fabricated positive electrodes, CR2032 type coin secondary batteries (a diameter of 20 mm, a height of 3.2 mm) were fabricated. A lithium metal was used for a counter electrode. As an electrolyte contained in the electrolyte solution, 1 mol/L lithium hexafluorophosphate (LiPF₆) was used. As the electrolyte solution, an electrolyte solution in which ethylene carbonate (EC) and diethyl carbonate (DEC) were mixed at EC:DEC=3:7 (volume ratio) was used. Note that for secondary batteries used for evaluating the cycle performance, 2 wt % of vinylene carbonate (VC) was added to the electrolytic solution. As a separator, 25-μm-thick polypropylene was used. A positive electrode can and a negative electrode can formed of stainless steel (SUS) were used.

### <Cycle Performance>

Charge and discharge cycle tests of the secondary batteries fabricated using the positive electrode active materials of Sample 1, Sample 2, Sample 4, Sample 6, and Sample 7 were performed. The CCCV charge (0.5 C, 4.4 V, a termination current of 0.01 C) and the CC discharge (0.5 C, 2.5 V) were repeatedly performed at 25° C., and then the cycle performance was evaluated. Here, 1 C was set to about approximately 137 mA/g.

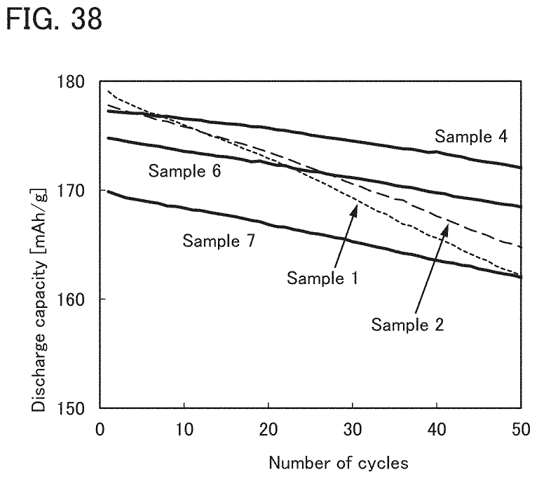

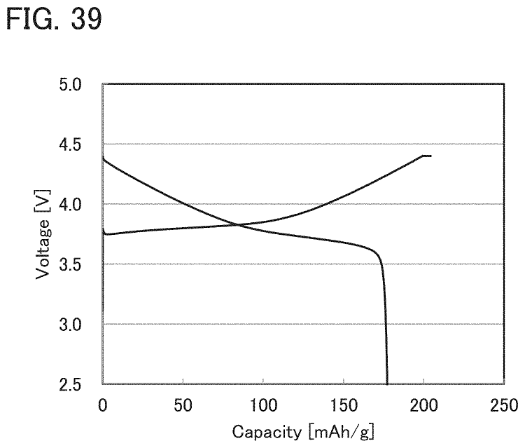

FIG. 38 shows the result of the obtained charge and discharge cycle performance. In FIG. 38, the horizontal axis represents the number of cycles and the vertical axis represents discharge capacity. FIG. 39 shows initial charge and discharge curves of Sample 4.

Charge and discharge cycles of the secondary batteries fabricated using the positive electrode active materials of Sample 1, Sample 4, Sample 8, and Sample 9 were performed. The CCCV charge (0.5 C, 4.6 V, a termination current of 0.01 C) and the CC discharge (0.5 C, 2.5 V) were repeatedly performed at 25° C., and then the cycle performance was evaluated. Here, 1 C was set to about approximately 137 mA/g.

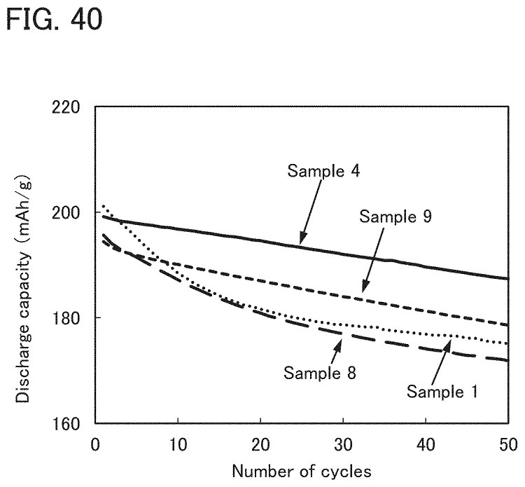

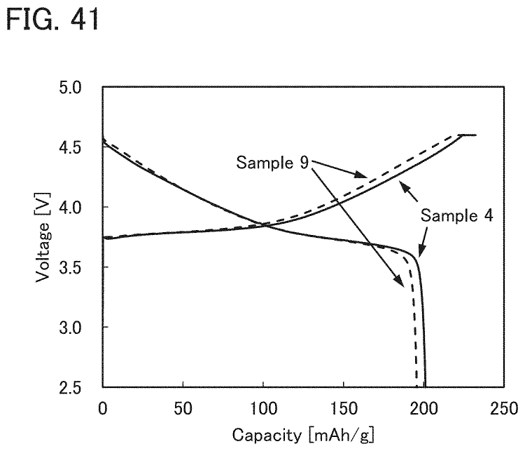

FIG. 40 shows the result of the obtained charge and discharge cycle performance. In FIG. 40, the horizontal axis represents the number of cycles and the vertical axis represents discharge capacity. Note that the results of the secondary batteries shown in FIG. 40 corresponding to Sample 1 and Sample 4 were obtained by evaluation of secondary batteries, which were fabricated to be different from the secondary batteries whose results are shown in FIG. 38. FIG. 41 shows the initial charge and discharge curves of Sample 4 and Sample 9.

According to the results in FIG. 38 and FIG. 40, a reduction in discharge capacity due to cycles can be inhibited when heating was performed together with the mixture including magnesium and fluorine after Step S31 to Step S33. Furthermore, it is found that the initial discharge capacity of the sample, whose heating temperature is increased, before charge and discharge cycles becomes lower than that of the sample whose heating temperature is 700° C.

### REFERENCE NUMERALS

100A_1: positive electrode active material, 100A_3: positive electrode active material, 100C: positive electrode active material, 330: particle, 331: region, 332: region, 332a: region, 332b: region, 336: grain boundary, 350: particle, 360: particle, 901: first raw material, 902: mixture, 903: mixture

1. A positive electrode active material for a lithium-ion secondary battery, comprising:
a first particle,
wherein the first particle comprises a first region and a second region,
wherein the second region is in contact with at least part of an outer side of the first region,
wherein the second region comprises a region whose outer edge corresponds to a surface of the first particle,
wherein the first region and the second region each comprise manganese, cobalt, oxygen, and fluorine,
wherein a ratio of manganese atoms to cobalt atoms, oxygen atoms, and fluorine atoms included in the first region is manganese:cobalt:oxygen:fluorine=M1:C1:O1:F1,
wherein a ratio of manganese atoms to cobalt atoms, oxygen atoms, and fluorine atoms included in the second region is manganese:cobalt:oxygen:fluorine=M2:C2:O2:F2,
wherein a ratio of the manganese atoms to the cobalt atoms M1/C1 in the first region is lower than a ratio of the manganese atoms to the cobalt atoms M2/C2 in the second region,
wherein a ratio of the fluorine atoms to the oxygen atoms F1/O1 in the first region is lower than a ratio of the fluorine atoms to the oxygen atoms F2/O2 in the second region, and
wherein the positive electrode active material is represented by a crystal structure whose space group is R-3m.

2. The positive electrode active material for a lithium-ion secondary battery, according to claim 1,
wherein the positive electrode active material further comprises nickel,
wherein the positive electrode active material further comprises a region where a ratio of an L3 edge to an L2 edge of nickel is higher than 3.3, and
wherein the ratio of the L3 edge to the L2 edge is obtained by measurement of the first region by electron energy loss spectroscopy.

3. The positive electrode active material for a lithium-ion secondary battery, according to claim 1, further comprising:
magnesium; and
a second particle,
wherein the second particle comprises a region in contact with the surface of the first particle,
wherein in the second particle, a concentration of magnesium is greater than or equal to 10 times a sum of concentrations of manganese, cobalt, and nickel, and
wherein in the first particle, a concentration of magnesium is less than or equal to 0.01 times a sum of concentrations of manganese, cobalt, and nickel.

4. The positive electrode active material for a lithium-ion secondary battery, according to claim 1, further comprising:
phosphorus; and
a third particle,
wherein the third particle comprises a region in contact with the surface of the first particle,
wherein in the third particle, a concentration of phosphorus is greater than or equal to 20 times a sum of concentrations of manganese, cobalt, and nickel, and
wherein in the first particle, a concentration of phosphorus is less than or equal to 0.01 times a sum of concentrations of manganese, cobalt, and nickel.

5. A lithium-ion secondary battery comprising:
a positive electrode comprising the positive electrode active material for a lithium-ion secondary battery, according to claim 1; and
a negative electrode.

6. An electronic device comprising:
the lithium-ion secondary battery according to claim 5; and
a display portion.

7. A vehicle comprising a battery pack comprising a combination of two or more lithium-ion secondary batteries,
wherein each of the lithium-ion secondary batteries is the lithium-ion secondary battery according to claim 5.

8. A method of manufacturing a positive electrode active material for a lithium-ion secondary battery, comprising:
forming a first mixture by mixing a lithium source, a fluorine source, and a magnesium source;
forming a second mixture by mixing a composite oxide comprising lithium, an element M, and oxygen with the first mixture; and
heating the second mixture to form a third mixture,
wherein in the step of the forming the second mixture, the element M is one or more selected from manganese, cobalt, nickel, and aluminum,
wherein in the step of the heating the second mixture, a heating temperature is higher than or equal to 500° C. and lower than or equal to 950° C.,
wherein number of magnesium atoms included in the magnesium source of the first mixture is greater than or equal to 0.0005 times and less than or equal to 0.02 times number of atoms of the element M included in the composite oxide of the second mixture, and
wherein number of fluorine atoms included in the fluorine source of the first mixture is greater than or equal to 0.001 times and less than or equal to 0.02 times the number of the atoms of the element M included in the composite oxide of the second mixture.

9. The method of manufacturing a positive electrode active material for a lithium-ion secondary battery, according to claim 8,
wherein the third mixture comprises a particle comprising the element M, oxygen, and fluorine, and
wherein number of magnesium atoms is less than 0.02 times number of atoms of the element M in the particle when a cross section of the particle is measured with a transmission electron microscope by energy dispersive X-ray spectroscopy.

10. The method of manufacturing a positive electrode active material for a lithium-ion secondary battery, according to claim 8,
wherein the third mixture comprises a particle comprising the element M, oxygen, and fluorine, and
wherein a concentration of magnesium is less than 0.02 times a concentration of the element M in the particle when the particle is measured by X-ray photoelectron spectroscopy.

11. The method of manufacturing a positive electrode active material for a lithium-ion secondary battery, according to claim 8,
wherein the heating temperature is higher than or equal to 600° C. and lower than 900° C.

12. The method of manufacturing a positive electrode active material for a lithium-ion secondary battery, according to claim 8,
wherein the heating temperature is higher than 630° C. and lower than 770° C.
